(19) United States
(12) Patent Application Publication
(10) Pub. No.: US 2021/0089860 A1
(43) Pub. Date: Mar. 25, 2021

(54) DIGITAL ASSISTANT WITH PREDICTIONS, NOTIFICATIONS, AND RECOMMENDATIONS

(71) Applicant: SAP SE, Walldorf (DE)

(72) Inventors: Dominik Heere, Heidelberg (DE); Steffen Knoeller, Neupotz (DE); Masoud Aghadavoodi Jolfaei, Wiesloch (DE); Simon Hoppermann, Nussloch (DE); Santo Bianchino, Schifferstadt (DE); Andre Sres, Olsbruecken (DE); Mirko Hin, Mannheim (DE); Janick Frasch, Mannheim (DE); Kuan Lu, Rauenberg (DE); Roman Rommel, Neustadt (DE)

(21) Appl. No.: 16/659,271

(22) Filed: Oct. 21, 2019

Related U.S. Application Data
(60) Provisional application No. 62/904,820, filed on Sep. 24, 2019.

(51) Int. Cl. G06N 3/00; G06N 5/04; G06N 20/00

(52) U.S. Cl. CPC G06N 3/004; G06N 20/00; G06N 5/04

(57) ABSTRACT

Techniques for implementing a digital assistant that provides proactive notifications to users, summarizes data and relevant situations, forecasts/predicts future outcomes, simulates outcomes under different assumptions, generates recommendations to improve observed or assumed situations, and provides explanations for calculated outcomes are disclosed. In some example embodiments, a computer system is configured to detect a data change in one or more data sources, the data change corresponding to a monitored data object, generate a predicted future value for the monitored data object based on the detected data change, identify a deviation between the predicted future value and a planned future value for the monitored data object, determine that the identified deviation is relevant for a specific user at a specific time and in a specific context, and cause a notification corresponding to the deviation to be displayed on a computing device based on the determination that the deviation is relevant.

### CROSS-REFERENCE TO RELATED APPLICATIONS

This application claims priority to U.S. Provisional Application No. 62/904,820, filed on Sep. 24, 2019, and entitled, “DIGITAL ASSISTANT WITH PREDICTIONS, NOTIFICATIONS, AND RECOMMENDATIONS,” which is hereby incorporated by reference in its entirety as if set forth herein.

### TECHNICAL FIELD

The present application relates generally to the technical field of electrical computer systems, and, in various embodiments, to systems and methods of implementing an adaptive simulation-based digital assistant that provides proactive notifications, situation-based predictions, and prescriptive recommendations to users.

### BACKGROUND

A digital assistant, also referred to as a virtual assistant, is a computer application program that is designed to assist a user by answering questions and performing tasks within computer systems. Current digital assistants rely on explicit user instruction to perform certain tasks, such as tasks related to data analysis, notifications related to data events, and other complicated processes. Furthermore, current digital assistants lack the ability to predict future events, to proactively generate notifications of predicted future events, and to recommend actions that address predicted future events. Additionally, current digital assistants do not employ adequate contextual awareness when presenting content to users. For example, the technical characteristics of a computing device, such as the device type (e.g., smartphone, laptop) and the screen size, are not factored in determining the presentation of content, thereby resulting in inefficient use of screen space and poor performance of the computing device (e.g., due to excessive content). The present disclosure addresses these and other technical problems that plague the computer functionality of digital assistant systems.

### BRIEF DESCRIPTION OF THE DRAWINGS

Some example embodiments of the present disclosure are illustrated by way of example and not limitation in the figures of the accompanying drawings, in which like reference numbers indicate similar elements.

FIG. 1 is a network diagram illustrating a client-server system, in accordance with some example embodiments.

FIG. 2 is a block diagram illustrating enterprise applications and services in an enterprise application platform, in accordance with some example embodiments.

FIG. 3 is a block diagram illustrating a digital assistant system, in accordance with some example embodiments.

FIGS. 4-11 illustrate a graphical user interface of a digital assistant, in accordance with some example embodiments.

FIG. 12 illustrates a proactive user notification flow, in accordance with some example embodiments.

FIG. 13 illustrates a user-requested processing flow, in accordance with some example embodiments.

FIG. 14 illustrates a summary pattern flow, in accordance with some example embodiments.

FIG. 15 illustrates a guided drill down pattern flow, in accordance with some example embodiments.

FIG. 16 illustrates a recommendation pattern flow, in accordance with some example embodiments.

FIG. 17 is a flowchart illustrating a method of implementing a digital assistant that provides proactive notifications to users, in accordance with some example embodiments.

FIG. 18 is a flowchart illustrating a method of implementing a digital assistant that provides an explanation for a deviation between a predicted future value and a planned future value for a monitored data object, in accordance with some example embodiments.

FIG. 19 is a flowchart illustrating a method of implementing a digital assistant that provides a recommendation of one or more actions to avoid a deviation, in accordance with some example embodiments.

FIG. 20 is a block diagram of an example computer system on which methodologies described herein can be executed, in accordance with some example embodiments.

### DETAILED DESCRIPTION

Example methods and systems for implementing a digital assistant that provides proactive notifications to users are disclosed. In the following description, for purposes of explanation, numerous specific details are set forth in order to provide a thorough understanding of example embodiments. It will be evident, however, to one skilled in the art that the present embodiments can be practiced without these specific details.

The implementation of the features disclosed herein involves a non-generic, unconventional, and non-routine operation or combination of operations. By applying one or more of the solutions disclosed herein, some technical effects of the system and method of the present disclosure are to provide a computer system that is configured to implement a digital assistant that provides proactive notifications to users. The digital assistant system of the present disclosure provides features such as proactiveness, context awareness, personalization, improved conversational interaction, an improved knowledge base, aggregation of data, recommendations of prescriptive actions, simulations of data in general, as well as simulations of prescriptive actions in particular, and explanations of data, as well as explanations of simulations and recommendations, thereby improving the functioning of the underlying computer system. Other technical effects will be apparent from this disclosure as well.

In some example embodiments, a digital assistant system monitors one or more data sources. The digital assistant system may detect a data change corresponding to a monitored data object from the monitoring of the one or more data sources. The digital assistant system may then generate a predicted future value for the monitored data object based on the detected data change, and then identify a deviation between the predicted future value for the monitored data object and a planned future value for the monitored data object. If the digital assistant system determines that the identified deviation is significant enough for a user or a user group in the respective current context (represented by, for example and not exclusively, a user's current and previous actions in a system or connected systems, a user's preferences, including preferences that were implicitly determined by the digital assistant, the device through which a user consumes that digital assistant's services, as well as their upcoming and planned activities), then it may cause a notification corresponding to the deviation to be displayed on a computing device, thereby providing a user of the computing device with advance notice of a future problem and enabling the user to take action to prevent or minimize the deviation. The digital assistant system may also provide explanations (such as correlated issues or root causes) for the deviation, as well as recommendations of actions that may be taken to prevent or minimize the deviation. The recommended actions may be determined based on simulations of a multitude of recommendation candidate actions that calculate their impact on the deviation (e.g., how much of a reduction in the deviation may be achieved by taking the action).

The methods or embodiments disclosed herein may be implemented as a computer system having one or more modules (e.g., hardware modules or software modules). Such modules may be executed by one or more hardware processors of the computer system. In some example embodiments, a non-transitory machine-readable storage device can store a set of instructions that, when executed by at least one processor, causes the at least one processor to perform the operations and method steps discussed within the present disclosure.

The details of one or more variations of the subject matter described herein are set forth in the accompanying drawings and the description below. Other features and benefits of the subject matter described herein will be apparent from the description and drawings, and from the claims.

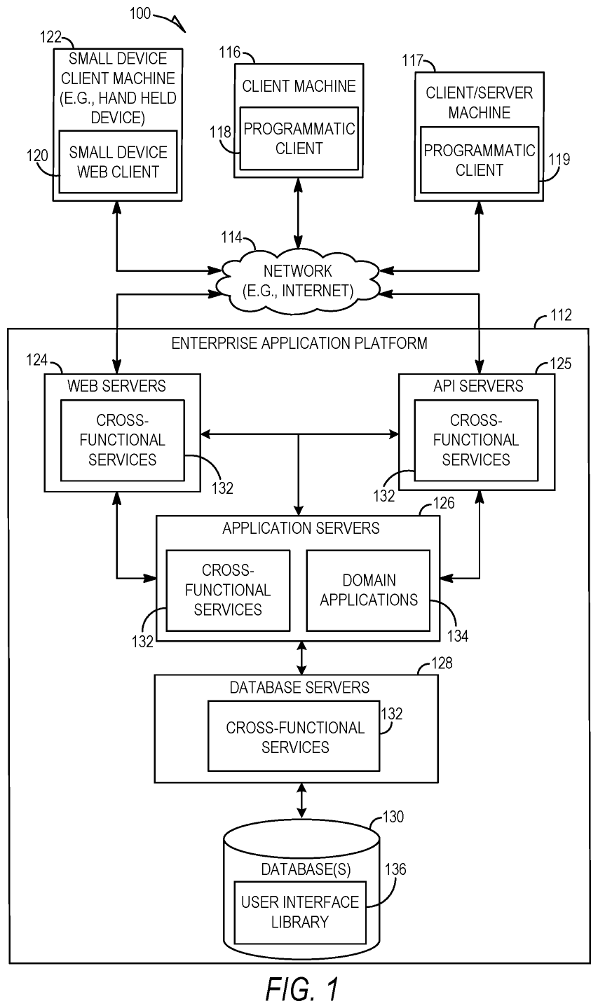

FIG. 1 is a network diagram illustrating a client-server system 100, in accordance with some example embodiments. A platform (e.g., machines and software), in the example form of an enterprise application platform 112, provides server-side functionality, via a network 114 (e.g., the Internet) to one or more clients. FIG. 1 illustrates, for example, a client machine 116 with programmatic client 118 (e.g., a browser), a small device client machine 122 with a small device web client 120 (e.g., a browser without a script engine), and a client/server machine 117 with a programmatic client 119.

Turning specifically to the example enterprise application platform 112, web servers 124 and Application Program Interface (API) servers 125 can be coupled to, and provide web and programmatic interfaces to, application servers 126. The application servers 126 can be, in turn, coupled to one or more database servers 128 that facilitate access to one or more databases 130. The cross-functional services 132 can include relational database modules to provide support services for access to the database(s) 130, which includes a user interface library 136. The web servers 124, API servers 125, application servers 126, and database servers 128 can host cross-functional services 132. The application servers 126 can further host domain applications 134.

The cross-functional services 132 provide services to users and processes that utilize the enterprise application platform 112. For instance, the cross-functional services 132 can provide portal services (e.g., web services), database services and connectivity to the domain applications 134 for users that operate the client machine 116, the client/server machine 117, and the small device client machine 122. In addition, the cross-functional services 132 can provide an environment for delivering enhancements to existing applications and for integrating third-party and legacy applications with existing cross-functional services 132 and domain applications 134. Further, while the system 100 shown in FIG. 1 employs a client-server architecture, the embodiments of the present disclosure are, of course, not limited to such an architecture, and could equally well find application in a distributed, or peer-to-peer, architecture system.

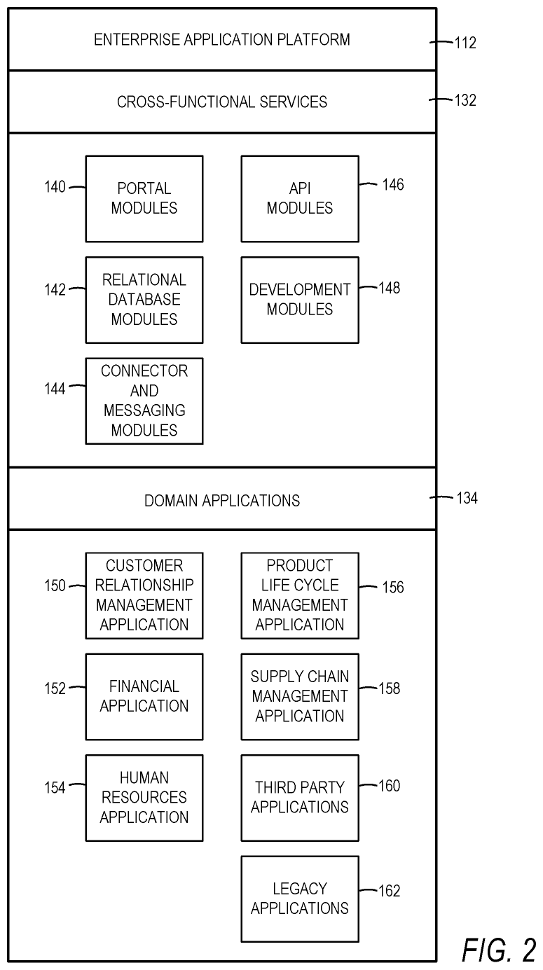

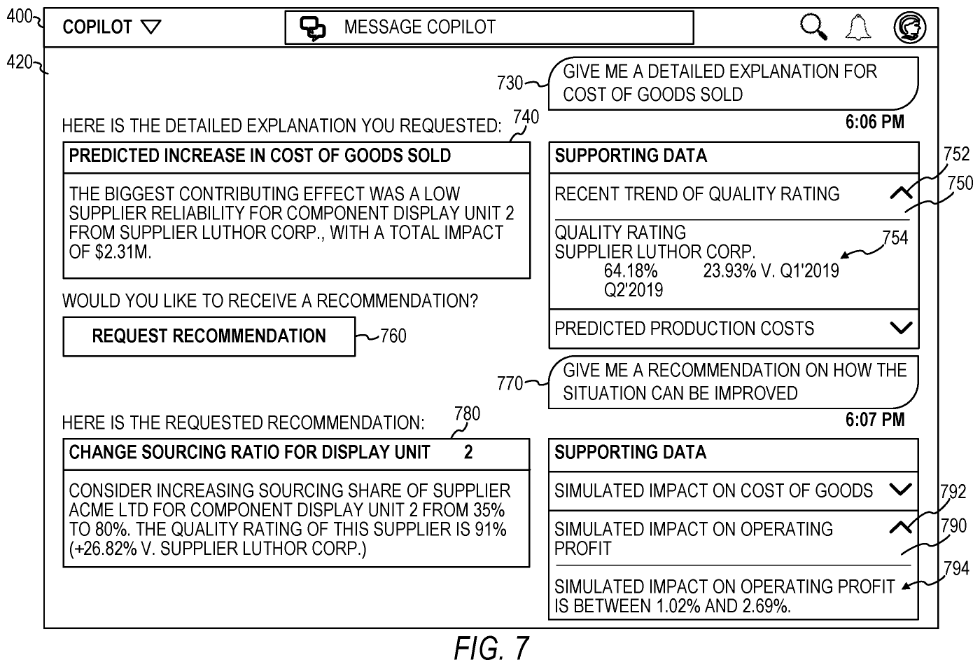

The enterprise application platform 112 can improve (e.g., increase) accessibility of data across different environments of a computer system architecture. For example, the enterprise application platform 112 can effectively and efficiently enable a user to use real data created from use by one or more end users of a deployed instance of a software solution in a production environment when testing an instance of the software solution in the development environment. The enterprise application platform 112 is described in greater detail below in conjunction with FIGS. 2-8.

FIG. 2 is a block diagram illustrating enterprise applications and services in an enterprise application platform 112, in accordance with an example embodiment. The enterprise application platform 112 can include cross-functional services 132 and domain applications 134. The cross-functional services 132 can include portal modules 140, relational database modules 142, connector and messaging modules 144, API modules 146, and development modules 148.

The portal modules 140 can enable a single point of access to other cross-functional services 132 and domain applications 134 for the client machine 116, the small device client machine 122, and the client/server machine 117. The portal modules 140 can be utilized to process, author and maintain web pages that present content (e.g., user interface elements and navigational controls) to the user. In addition, the portal modules 140 can enable user roles, a construct that associates a role with a specialized environment that is utilized by a user to execute tasks, utilize services, and exchange information with other users within a defined scope. For example, the role can determine the content that is available to the user and the activities that the user can perform. The portal modules 140 include a generation module, a communication module, a receiving module and a regenerating module. In addition, the portal modules 140 can comply with web services standards and/or utilize a variety of Internet technologies including JAVA®, J2EE, SAP's Advanced Business Application Programming Language (ABAP®) and Web Dynpro, XML, JCA, JAAS, X.509, LDAP, WSDL, WSRR, SOAP, UDDI and MICROSOFT®.NET®.

The relational database modules 142 can provide support services for access to the database(s) 130, which includes a user interface library 136. The relational database modules 142 can provide support for object relational mapping, database independence, and distributed computing. The relational database modules 142 can be utilized to add, delete, update and manage database elements. In addition, the relational database modules 142 can comply with database standards and/or utilize a variety of database technologies including SQL, SQLDBC, Oracle, MySQL, Unicode, JDBC, or the like.

The connector and messaging modules 144 can enable communication across different types of messaging systems that are utilized by the cross-functional services 132 and the domain applications 134 by providing a common messaging application processing interface. The connector and messaging modules 144 can enable asynchronous communication on the enterprise application platform 112.

The API modules 146 can enable the development of service-based applications by exposing an interface to existing and new applications as services. Repositories can be included in the platform as a central place to find available services when building applications.

The development modules 148 can provide a development environment for the addition, integration, updating, and extension of software components on the enterprise application platform 112 without impacting existing cross-functional services 132 and domain applications 134.

Turning to the domain applications 134, the customer relationship management application 150 can enable access to and can facilitate collecting and storing of relevant personalized information from multiple data sources and business processes. Enterprise personnel that are tasked with developing a buyer into a long-term customer can utilize the customer relationship management applications 150 to provide assistance to the buyer throughout a customer engagement cycle.

Enterprise personnel can utilize the financial applications 152 and business processes to track and control financial transactions within the enterprise application platform 112. The financial applications 152 can facilitate the execution of operational, analytical, and collaborative tasks that are associated with financial management. Specifically, the financial applications 152 can enable the performance of tasks related to financial accountability, planning, forecasting, and managing the cost of finance.

The human resource applications 154 can be utilized by enterprise personnel and business processes to manage, deploy, and track enterprise personnel. Specifically, the human resource applications 154 can enable the analysis of human resource issues and facilitate human resource decisions based on real-time information.

The product life cycle management applications 156 can enable the management of a product throughout the life cycle of the product. For example, the product life cycle management applications 156 can enable collaborative engineering, custom product development, project management, asset management, and quality management among business partners.

The supply chain management applications 158 can enable monitoring of performances that are observed in supply chains. The supply chain management applications 158 can facilitate adherence to production plans and on-time delivery of products and services.

The third-party applications 160, as well as legacy applications 162, can be integrated with domain applications 134 and utilize cross-functional services 132 on the enterprise application platform 112.

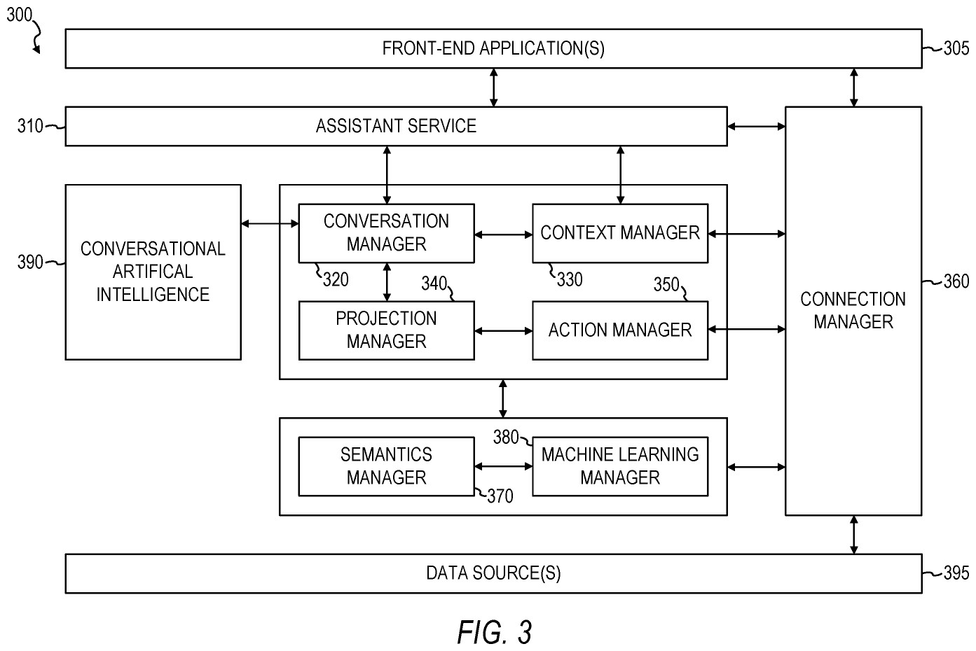

FIG. 3 is a block diagram illustrating a digital assistant system 300, in accordance with some example embodiments. The digital assistant system 300 significantly reduces complexity of user interfaces up to the degree of automating most parts of the user interaction and enables users to keep track of multiple tasks simultaneously. The digital assistant system 300 may employ such technologies as artificial intelligence (AI), in addition to and beyond natural language processing and speech recognition. Among these are supervised and unsupervised machine learning methods, predictive analytics and prescriptive analytics. The digital assistant system 300 employs new interaction patterns that help users simplify long-winded and rather data-driven tasks, and transitions from a reactive to a proactive working mode.

In some example embodiments, the digital assistant system 300 comprises any combination of one or more of one or more front end applications 305, an assistant service 310, a conversation manager 320, a context manager 330, a projection manager 340, an action manager 350, a connection manager 360, a semantics manager 370, a machine learning manager 380, a conversational artificial intelligence unit 390, and one or more data sources 395. The components 305, 310, 320, 330, 340, 350, 360, 370, 380, 390, and 395 can reside on a computer system, or other machine, having a memory and at least one processor (not shown). In some embodiments, the components 305, 310, 320, 330, 340, 350, 360, 370, 380, 390, and 395 can be incorporated into the application server(s) 126 in FIG. 1. However, it is contemplated that other configurations of the components 305, 310, 320, 330, 340, 350, 360, 370, 380, 390, and 395 are also within the scope of the present disclosure.

In some example embodiments, one or more of the components 305, 310, 320, 330, 340, 350, 360, 370, 380, and 390 is configured to provide a variety of user interface functionality, such as generating user interfaces, interactively presenting user interfaces to the user, receiving information from the user (e.g., interactions with user interfaces), and so on. Presenting information to the user can include causing presentation of information to the user (e.g., communicating information to a device with instructions to present the information to the user). Information may be presented using a variety of means including visually displaying information and using other device outputs (e.g., audio, tactile, and so forth). Similarly, information may be received via a variety of means including alphanumeric input or other device input (e.g., one or more touch screen, camera, tactile sensors, light sensors, infrared sensors, biometric sensors, microphone, gyroscope, accelerometer, other sensors, and so forth). In some example embodiments, one or more of the components 305, 310, 320, 330, 340, 350, 360, 370, 380, and 390 is configured to receive user input. For example, one or more of the components 305, 310, 320, 330, 340, 350, 360, 370, 380, and 390 can present one or more GUI elements (e.g., drop-down menu, selectable buttons, text field) with which a user can submit input. In some example embodiments, one or more of the components 305, 310, 320, 330, 340, 350, 360, 370, 380, and 390 is configured to perform various communication functions to facilitate the functionality described herein, such as by communicating with a computing device of a user via the network 114 using a wired or wireless connection.

The digital assistant system 300 is configured to provide a number of features that improve the functioning of digital assistants and their underlying computer systems. One of the features that the digital assistant system may be configured to provide is proactiveness. In some example embodiments, the digital assistant system 300 is configured to continuously monitor one or more data sources 395 in the background and proactively notify the user (e.g., in a push fashion) about relevant situations that require the user's attention. Monitored data channels may include, but are not limited to, business process updates, approval workflows, enterprise resource planning (ERP) notification channels, business situation frameworks, but also less structured enterprise-internal sources such as e-mail accounts, electronic calendars and external sources like social media and news articles, investor relations, and competitor press releases. In particular, monitored data channels include structured and unstructured data stored in or managed through computer systems, such as ERP systems, database systems, data lakes or other enterprise IT systems. The digital assistant system 300 may subscribe itself to these data channels to receive push updates (e.g., if supported by the data source 395), or may frequently poll the data source(s) 395 for updates.

Upon observing a relevant (e.g., sufficiently significant) data event (e.g., a change in data), internal data processing and enrichment steps of the digital assistant system 300 may be triggered (e.g., generation of a summary, re-execution of a prediction or simulation, generation of prescriptive recommendations, etc.). Based on the observed data change or based on the results of a thereby triggered processing step, the digital assistant system 300 may issue a data event into a suitable outgoing channel (e.g., meeting preparation, approval process, daily business process updates, urgent notifications, etc.). The user may be notified if and when the event pushed into one of the channels appears to be relevant for them. Furthermore, the calculated information artifacts may be available for ad-hoc calls by the user. To realize such a proactive operational flow, the digital assistant system may utilize push channels, asynchronous dialog, automatic simulations, data access, meeting organization/setup, predictive analytics, big data streaming, ranking, machine learning, and events and subscription.

Another one of the features that the digital assistant system 300 may be configured to provide is context awareness. A central challenge of the proactive user notification pattern is how to manage, and in some cases limit, the number and timing of push notifications, in order to avoid information overload to the user and the user's computing device. In some example embodiments, the digital assistant system 300 is configured to, instead of directly pushing every event directly to the user, analyze the content and metadata (e.g., influenced semantic identifiers) of a notification together with context information of the user and situation to predict relevance and importance of the notification, and to perform a (re-)ranking (e.g., in case of several notifications in a short time frame), summarization/enrichment, postponing or filtering of a notification and information artifact. The digital assistant system 300 may determine to snooze a message until a certain point in time or until a specific event happens, and even trigger directly a follow up action (e.g., request additional data such as further related key performance indicators (KPIs), proactively request a voice summarization, schedule a meeting, or block time in a user's electronic calendar for briefing them).

The relevance prediction and classification models of the digital assistant system 300 can be enriched by using explicitly user defined rules, as well as explicit and implicit user feedback that is used to retrain machine learning models in a supervised manner. To realize this context-aware behavior, the digital assistant system 300 may utilize application context, business context, data state/context, device context, external context, geographic context, domain context, user context, user tracing, topic storage, semantics, ranking, contexts management, common user knowledge, topic extraction, long-term memory, and machine learning.

The feature of context awareness of the digital assistant system may in particular leverage so-called implicit user feedback, by which we refer to feedback that is generated from automatically analyzing a users' usage data (e.g., how they react to notifications, whether they frequently request certain additional information, etc.) within the boundaries of the legal, contractual and consensual frame, such as by using machine learning and artificial intelligence operations and techniques.

Yet another one of the features that the digital assistant system 300 may be configured to provide is personalization. In some example embodiments, the digital assistant system 300 is configured to provide role-specific and user-specific personalized adaptions and alterations. Leveraging its self-learning capabilities, which are discussed in more detail below, the digital assistant system 300 may evolve its user-specific behavior based on the continued interaction with the user. The gain of any new, user-specific knowledge may, in some embodiments, be reflected in a user-specific knowledge graph, or some other type of knowledge representation (e.g., trained machine learning models), that leverages and enhances the domain-specific and role-specific knowledge representations of the digital assistant system 300. Furthermore, certain machine learning and analytical models may have user-specific adaptations in the form of stacked models, transfer learning and surrogate models that are updated (e.g., in form of a re-training) upon observing a significant change in user personalization information. Even further, ranking, prioritization, filtering, and aggregation mechanisms from the realization of the context awareness features of the digital assistant system 300 may be customized for a user.

Additionally, access by the digital assistant system 300 to data sources, its connections to source systems and its interactions with third-party systems can be customized. For example, additional credentials for interaction with a system or additional permissions in a system that go beyond the default permissions that come with the user's business role can be configured. On the other hand, access by the digital assistant system 300 to certain systems or consent to perform certain analyses on data can also be restricted to respect personal user preferences, concerns with respect to data privacy, as well as legislation. Besides implicit adaptation, a user can also customize their “persona” (e.g., the behavior of their instance of the digital assistant) explicitly, both during onboarding and at runtime. Personalization may be achieved, in some cases, by way of a guided dialog in which the user is presented with several sample notifications for which they have to express their preferences. In some other cases, personalization may be achieved by way of direct adjustment of topic weights onto which the persona is mapped. In particular, a user can choose to remove all subscriptions to a topic for a certain period of time (e.g., a temporary mute of topic) or permanently (e.g., unfollow topic). In order to implement the personalization capabilities, the digital assistant system 300 may utilize feedback loops, common user knowledge, contexts management, data privacy controls, device context, dialog engine, privacy consent management, relevant contacts retrieval, user context, user tracing. ranking, and machine learning.

Yet another one of the features that the digital assistant system 300 may be configured to provide is conversational interaction. In some example embodiments, the digital assistant system 300 is configured to provide user interaction in textual and/or oral form via a dialogue system. The digital assistant system 300 may support both user-initiated dialogues, where a user requests (e.g., pulls) relevant information/insights, as well as system-initiated dialogues, where a user receives push notifications (e.g., depending on the user's current context) without an explicit prior request via the conversational agent. The interaction with the digital assistant system 300 may be made available through a variety of channels (e.g., messaging apps) using chat bot technology (e.g., SAP CoPilot, Microsoft Skype®, Slack®, Microsoft Teams, and similar channels that lie outside the classical screen-oriented dialogs). The user may be able to set situation-specific preferences for their favorite interaction channels. The conversation manager 320 may combine abilities to recognize a broad range of user intents and entities and to generate natural language texts, such as for push messages and responses to information/interaction requests by the user.

One way in which the digital assistant system 300 improves upon the functionality of conventional conversational agents is through the use of a conversational memory in conversation dialogs that continuously organizes and makes available relevant information across longer periods of time, such as days, months, and years. This long-term memory may also assist with the realization of the features of context-awareness, personalization, knowledge, and self-learning, which rely on having entities and topics stored/remembered over a longer period. Furthermore, a user may be able to initiate conversations with the digital assistant system 300 on multiple topics with overlapping time frames and switch back and forth between different domain specific skills. In order to implement the conversational interaction features, the digital assistant system 300 may utilize sentiment analysis, natural language generation, machine learning, multi-lingual capabilities, Speech2Text, Text2Speech, machine reading comprehension, analytics, question answering, semantics, push channels, knowledge graphs, entity extraction and relations, bot persona, asynchronous dialog, text summarization, frame management, mapping of entities, topic extraction, and topic storage.

Yet another one of the features that the digital assistant system 300 may be configured to provide is a strong knowledge base. In some example embodiments, the digital assistant system 300 is configured to acquire, process, and persist generalized knowledge about the user, the enterprise domain, the business domain, and common world knowledge. In addition to direct persistence of such knowledge, the system may, in some embodiments, persist references to the original knowledge source. The acquired knowledge base may be used to enable logical inference (e.g., reasoning), explore data sources, enrich information, rank information, and disambiguate entities. A semantic catalog of the semantics manager 370 may be used to represent rich and complex knowledge about knowledge entities (e.g., things, resources, processes, persons, etc.) and their relations among each other. The semantic manager 370 may use ontologies (e.g., knowledge graphs) for explicit and formal representation of knowledge.

While knowledge graphs can be constructed manually by explicit modelling of a specific domain (e.g., using expert knowledge), the digital assistant system 300 may also employ mechanisms to enrich, enhance, and update knowledge graphs automatically, both from enterprise-internal structured and unstructured data sources, as well as from enterprise-external data sources. In particular, linked open data may be used to extract and incorporate knowledge from publicly available knowledge graphs. Besides explicit knowledge representation in form of knowledge graphs, the digital assistant system 300 may leverage machine learning models to implicitly store knowledge in a more abstract format for specific purposes (e.g., dependencies of certain KPIs on influence factors, forecasting models, relevance prediction models, etc.). In order to provide the strong knowledge base capability, the digital assistant system 300 may use knowledge graphs, entity extraction and relations, big data streaming, business context, business situations learning, case-based reasoning, clustering, common user knowledge, data access, data history, data privacy controls, data state/context, data visualization, domain knowledge store, dynamic data view, external context, external information, information sources, long-term memory, machine learning, machine reading comprehension, mapping of entities, predictive analytics, relevant contacts retrieval, enterprise domain context, search, semantics, topic extraction, topic storage, question answering, and automatic knowledge acquisition.

Yet another one of the features that the digital assistant system 300 may be configured to provide is aggregation. The digital assistant system 300 may have access to a wide range of information sources (e.g., data sources 395), covering both enterprise-specific data and generic data, such as data from the business domain, the enterprise domain, and common world knowledge. In order to avoid overwhelming the user and the user's computing device with excessive amounts of information in a given situation, in some example embodiments, the digital assistant system 300 is configured to aggregate information in order to distill the essence of what is relevant for the specific user and the specific situation. The digital assistant system 300 may use machine learning algorithms to predict the relevance of an available information artifact for a user given the user's context and given the other available information artifacts and their semantic relationship among each other. The digital assistant system 300 may intelligently rank artifacts and limit the number of returned items depending on the user's context. Furthermore, textual sources may be summarized using natural language processing.

Yet another one of the features that the digital assistant system 300 may be configured to provide is simulation. Through the use of machine learning methods, the digital assistant system 300 may reduce high-dimensional, structured and semi-structured data from data sources 395 into smaller-dimensional, more abstract representations (e.g., machine learning and (semi-)analytical models) that allow it to infer consequences from newly observed data. In certain contexts, the digital assistant system 300 may apply modifications to specific, accordingly labeled input variables and feed this modified input data into suitable representations (e.g., models) in order to perform “what-if” analyses. In this respect, the digital assistant system 300 may provide simulation capabilities. Simulation capabilities are closely related with predictive capabilities and predictive analytics, and they may be used to provide prescriptive analytics, which will be discussed in further detail below. Analytical and machine learning models of the digital assistant system 300 may be designed for low-key administration (e.g., great emphasis may be given to continuous monitoring of model performance and re-training jobs may be automatically triggered if model performance deteriorates). In particular, some of the machine learning models may explore periodically whether new, potentially relevant features (e.g., new columns in relevant tables, or new relationships in semantic models) are available and automatically include these features where feasible and beneficial from a model performance point of view.

Yet another one of the features that the digital assistant system 300 may be configured to provide is prescriptive capabilities, which may comprise information abstraction and summarization (e.g., descriptive analytics), information inference (e.g., predictive analytics), as well as conditional inference (e.g., simulation) paired with optimization algorithms to identify optimal configurations of manipulatable parameters to ultimately derive a recommendation for specific actions in the business domain. In some example embodiments, fundamentals for the prescriptive capabilities of the digital assistant system 300 are provided by the machine learning manager 380, which orchestrates and administrates analytical models for different combinations of semantic entities and analytical tasks. The machine learning manager 380 may provide recommendations (e.g., measures and counter-measures) for detected business situations/issues through a variety of different techniques, ranging from anomaly detection to case-based reasoning, mathematical optimization and expert systems. The decision of which approach is best suited for a given issue may be derived from machine learning-based user preference analysis, from a knowledge graph that maps root causes to recommendation candidates, all well as from other explicit and implicit knowledge sources.

Yet another one of the features that the digital assistant system may be configured to provide is self-explaining. In some example embodiments, the digital assistant system 300 is configured to provide explainability and transparency of procedures and analytical results. In many situations, adoption of complex analytical and machine learning-based software systems is inhibited by a lack of trust. In order to reach an identical level of trust, the requirements on result quality for systems that are complex to understand are typically drastically higher than the requirements on a system that is transparent and whose “reasoning” a user can follow. Based on the assumption that state-of-the-art intelligent algorithms still produce non-negligible rates of error in many domains, the digital assistant system 300 embraces this user behavior and focuses on providing the user with the means to understand root causes behind analytical results and to follow the reasoning of the digital assistant system 300. Transparency on the activities and execution flows of the digital assistant system 300 may be provided through its execution plans, which contain additional semantic information, and templates for explanations of certain scenarios and scenario groups. The user interactions (e.g., conversations) of the digital assistant system 300 provide functionality (e.g., through buttons or natural-language commands) to drill further into a provided result, which retrieves additional explaining information, as well as links to relevant source transactions and auxiliary dashboards. Further explanation artifacts may include, but are not limited to, informing the user about active conversation topics, detected user intents and semantic URIs, associated priorities, triggered execution plans, involved data sources and source systems, as well as leveraged machine learning models.

Yet another one of the features that the digital assistant system may be configured to provide is argumentative capabilities. Beyond providing explanations for its activities and produced results, the digital assistant system 300 may act as a dialog partner for making business decisions in the sense that a user can ask the digital assistant system 300 to provide lists of arguments and artifacts supporting or discouraging a specific decision. Furthermore, a user can “challenge” information and insights provided by the digital assistant system 300, in which case the digital assistant system 300 may outline why, for example, a specific recommendation was provided. The argumentative capability of the digital assistant system 300 may be enhanced by its semantic knowledge graph and search capabilities, paired with text comprehension, which allows the digital assistant system 300 to access, search and “understand” large quantities of available textual resources and link the extracted information to the topic of the user's request. Machine learning paired with sentiment analysis may be used to classify relevance of extracted information entities for a specific topic and argument side (e.g., whether it is an argument for or against a certain decision). Furthermore, the simulation capabilities may be used to derive implications of certain alternative decisions, the summarization skills and aggregation capabilities may allow the digital assistant system 300 to present the information in a concise and comprehensible fashion, and the self-explaining capabilities may allow the digital assistant system 300 to iteratively provide additional details to the user upon request.

Yet another one of the features that the digital assistant system may be configured to provide is administrative capabilities. In some example embodiments, the digital assistant system 300 is configured to increase user productivity by taking over administrative tasks and automating simple, repetitive activities. This administrative capability may be triggered by explicit user request or proactively from analysis of recently requested and viewed data in combination with the user's context that is run in the background and leads the digital assistant system 300 to suggest one-time or repetitive, automated execution of certain activities. The administrative capabilities may include, but are not limited to the creation of follow-up tasks (including sub-activities like reminding a user when due and appropriate, intelligent meeting time and place suggestion, meeting participant suggestion depending on meeting topic, meeting setup, room reservation, ordering of catering, etc.), execution of workflow task (e.g., approval processes), meeting-related activities (e.g., administration of recordings, automatic creation of transcripts and meeting minutes), as well as delegation of activities.

Yet another one of the features that the digital assistant system may be configured to provide is self-learning. In some example embodiments, the digital assistant system 300 is configured to continuously update its internal knowledge representations. The sources of information for this feature may include explicit and implicit user feedback, as well as connected data sources 395 that the digital assistant system 300 regularly accesses to check for added, updated, and outdated information. Within the limitations of legal and contractual obligations as well as user consent (e.g., privacy settings), the self-learning skills aim at sharing updated knowledge representations among different users and tenants, in order to provide the best possible user experience and keep required feedback iterations low for individual users. The digital assistant system 300 may facilitate the sharing of information artifacts among users and tenants even in the case where confidential or otherwise restricted data is involved through its built-in anonymization functionality (e.g., by sharing only abstracted versions of data artifacts that are limited non-critical attributes essential to the self-learning task).

Furthermore, through the use of tenant-specific, business domain-specific, enterprise domain-specific, and user-specific knowledge representations, the digital assistant system 300 can personalize its self-learning capabilities. While a user can provide simple, one-click feedback to each message of the digital assistant system 300, optional follow-up questions may be provided to allow a user to be more specific in their feedback. Even binary feedback allows the digital assistant system 300 to improve its behavior, by taking into account the current user context. More granular feedback, on the other hand, allows the digital assistant system 300 to improve its behavior significantly faster. Explicit user feedback may be followed in the digital assistant system 300 by immediate reactions and by longer-term reactions. Immediate reactions include hiding or snoozing currently undesired messages, updating detected entities or user intents in conversations, as well as proposing alternatives. Longer-term reactions include asynchronously scheduled updates to machine learning and analytical models, as well as to ranking mechanisms and knowledge representations. Longer-term reactions may also take implicit user feedback (e.g., information about the user's perception or valuation of certain presented content or other system actions that is not captured through explicit user action, but rather from implicitly analyzing the user's behavior in the system immediately before, during and after a situation) into account in the same manner.

Furthermore, as a background activity, the digital assistant system 300 may access and analyze connected systems and data sources 395 for the purpose of automatically updating its knowledge graphs and re-training its machine learning models in case of significant data changes or deteriorating model quality. In some example embodiments, the digital assistant system 300 is configured to perform automated creation of data journeys for relevant semantic entities, which allows it to track, as well as assess the impact of changes, thereby forming the basis of part of the prescriptive capabilities of the digital assistant system 300. In addition, the digital assistant system 300 may monitor a user's activities in connected systems and suggest automating activities where it detects repetitive system tasks being performed manually by a user. The digital assistant system 300 may also suggest activities to a user based on configuration and behavior of other users, as well of similarity in terms of personality and role.

The information exchange between different components of the digital assistant system 300 (e.g., between different service/manager components) may be based on semantic uniform resource identifiers (URIs) that are maintained in catalogs. This information exchange helps the digital assistant system 300 to bridge the gap between user-friendly, personalizable human system interactions on the one hand, and highly structured data artifacts from a range of different sources on the other hand. The relationships among the various semantic URIs are modeled in the form of different graphs that can be accessed by the individual components of the digital assistant system 300 to harmonize their interactions.

The components of the digital assistant system 300 may be rather loosely coupled. Each component may have its own governance functionality, such as logging, health checking of its entities and failure handling. However, there may be shared functionality for end-to-end monitoring and administration that leverages harmonized functionality from all components.

In some example embodiments, invocation of the components of the digital assistant system 300 are implemented asynchronously, and time intensive requests (e.g., data manipulations) may be managed through message queues that permit prioritization depending on the requests' content and metadata. Requests may reference semantic URIs for intents and tasks, as well as for data artifacts.

In some example embodiments, the assistant service 310 is configured to provide a unique interface for the digital assistant system 300 to interact with various front-end applications 305. In some example embodiments, the front-end applications 305 comprise user interfaces or parts of software or a website that a user sees on the screen and acts on to enter commands or to access other parts of the software or website. Examples of the front-end applications 305 include, but are not limited to, SAP Fiori® Launchpad (FLP), SAP CoPilot, and other messaging apps and communication channels, such as Slack®, Microsoft Skype®, as well as e-mail tools, text messaging tools, and other collaboration tools. In some example embodiments, the assistant service 310 is responsible for authentication and authorization of the client, such as a computing device that a user is using to access the functionality of the digital assistant system 300.

In some example embodiments, the assistant service 310 routes any incoming messages to the conversation manager 320. Conversely, the assistant service 310 may forward messages from the conversation manager 320 to the intended output channels (e.g., web UI, connected mobile device/mobile app, email/messenger integration, calendar integration, etc.). Incoming and outgoing messages routed through the assistant service 310 may comprise rich text messages in natural language and metadata. Outgoing messages may, in addition, comprise feature diagrams (e.g., charts), smaller tables, as well as interaction functionality. The assistant service 310 is able to maintain multiple conversations with the same output channel (e.g., SAP Fiori ®Launchpad/CoPilot) to allow multiple, topic-specific interactions of a user for the digital assistant system 300 at the same time.

In some example embodiments, the assistant service 310 continuously runs as a background thread to enable proactiveness capability even without any UI connected. The assistant service 310 is configured to queue messages, if a required client is currently not connected, and it can trigger a re-evaluation of a message by the conversation manager 320, if the message has been queued for too long a time period.

In some example embodiments, the assistant service 310 is connected to one or more user interaction channels (e.g., SAP Fiori® Launchpad/CoPilot, other front-end apps, messengers, collaboration tools) on the one end, and to the conversation manager 320 and the context manager 330 on the other end. The interface to the conversation manager 320 serves for the exchange of user interaction messages consisting of natural language text and other rich elements. The interface of the assistant service 310 to the context manager 330 is used to exchange user authentication and technical session information.

For certain user interactions (e.g., e-mail), the assistant service 310 leverages the connection manager 360. This connection is also used to support front-end specific enrichment/processing of output (e.g., to call external APIs to enable text-to-speech and speech-to-text functionality).

In combination with the context manager 330 and the conversation manager 320, the assistant service 310 enhances current routing backends and supports multi-channel interactions that can be handed off to or continued on other media (e.g., transition from a web front end to a messenger app on a mobile phone, etc.), as well as topic-specific conversations (e.g., multiple conversational threads at the same time). Furthermore, the assistant service 310 enables message-specific user feedback as a key ingredient to improve the performance of the digital assistant system 300 (e.g., result quality).

In some example embodiments, the conversation manager 320 is the main processing unit for user interaction. On the one hand, the conversation manager 320 transforms structured, semantic information that it receives from other components of the digital assistant system 300 into user-tailored messages consisting of natural language text, formatting, user-interaction functionality (e.g., buttons or controls), diagrams and other data representations, as well as metadata, such as communication channel, message urgency, etc. On the other hand, the conversation manager 320 may receive user input in textual (e.g., in form of natural language) or (semi-)structured format (e.g., feedback, control interaction, etc.) and orchestrate extraction of semantic entities, data values, user intents and auxiliary context information (e.g., incidental information, user sentiment, etc.) with the help of the context manager 330 and the semantics manager 370.

To enable a natural language dialog with the user, the conversation manager 320 may leverage and orchestrate multiple domain-specific natural language understanding/generating chat bots. In case of a user-initiated conversation, the conversation manager 320 may identify the appropriate domain bot through a machine learning-based topic detection mechanism that takes into account the user context, and default to a generic bot until the topic can be identified unambiguously. If a dialog is triggered by an event (e.g., a data change event), the conversation manager 320 may identify the appropriate domain bot through a machine learning-based classifier that takes into account the event's metadata, its semantic content, thereby leveraging the semantics manager 370, and the user context of the implicated user(s). The chat bots can extract user intents, semantic entities and data values from textual statements. Conversely, they can produce natural language texts (e.g., entire messages and fragments to be used in rich templates, such as charts) for given intents, semantic entities, data values and additional control parameters based on natural language generation as well as intent-specific, target channel-specific and semantic-specific templates.

In some example embodiments, across domains, the conversation manager 320 makes use of the semantics manager 370 to resolve semantic entities (e.g., references to data objects, KPIs, etc.) into natural-language expressions for textual dialog message parts, diagram captions and enrichments, button or control captions, etc. and vice versa. Using the semantics manager 370, the conversation manager 320 may identify appropriate data visualization formats for semantic entities. The conversation manager 320 has built-in functionality to generate situation-specific, event-specific and user context-specific visualizations of given structured, semantic data references.

Besides dialog message understanding and generating functionality, the conversation manager 320 may invoke the projection manager 340 when a detected intent requires the execution or administration of a data processing job. Based on the current user context and event nature, the conversation manager 320 determines an appropriate dialog output channel and urgency class. If a message cannot be delivered via the intended output channel, the conversation manager 320 re-evaluates output channel and urgency class upon notification by the assistant service 310.

In some example embodiments, the conversation manager 320 keeps user-and-tenant-specific mid-term memories across individual conversations with key topics and entities recently discussed to pre-fill the short-term conversational memory of newly started conversations with a user. The mid-term memories are harmonized across different communication channels to permit hand-off of an ongoing user conversation to a different medium. In some example embodiments, the conversation manager 320 stores anonymized conversation journey data for the purpose of improving its machine learning models as well as its language models.

In some example embodiments, the conversation manager 320 interacts bidirectionally with the assistant service 310 through rich dialog messages consisting of natural language text, diagrams, and interaction functionality (e.g. buttons), as well as metadata, such as session context information, urgency class and formatter information. The conversation manager 320 may request and receive user context information from the context manager 330. The conversation manager 320 may notify the context manager 330 about ongoing conversations and, on request, propagate conversation metadata to the context manager 330 to update the user context for a specific user. The conversation manager 330 may leverage the semantics manager 370 to resolve semantic entities from natural language descriptions and, conversely, to obtain natural language descriptions and explanations for semantic entities. In order to update its internal machine learning and language models based on the most recent user interaction data, the conversation manager 320 may leverage the machine learning manager 380. In some example embodiments, the conversation manager 320 may communicate with the projection manager 340 to hand off worker jobs for fetching, storing and processing data, as well as administrative tasks. Conversely, the conversation manager 320 can be invoked by the projection manager 340 to assess a data event and initiate a backend-triggered, proactive notification of the user about a situation where his attention is required.

In some example embodiments, the conversation manager 320 leverages the functionality of the conversational AI unit 390 for its domain-specific and generic chat bots and extends the default features of the conversational AI unit 390 by providing user context-dependent topic detection and domain classification, proactive dialogue initializations, as well as pro-active subject initializations in ongoing conversations, communication via rich messages including charts and structured interaction elements, and mid-term and long-term conversational memory management, as well as initialization of short-term conversational memory across bots and communication channels.

In some example embodiments, the context manager 330 is configured to acquire, organize, and make available context information about users and their current situation. The context information is leveraged by the digital assistant system 300 to filter and process information in a situation-specific fashion, and to personalize results and presentations, as well as to generally improve user experience.

In some example embodiments, the context manager 330 stores context information in the form of knowledge graphs. Subject to user consent, the digital assistant system 300 keeps current and recent personal information, such as usage information of the digital assistant system 300 and connected systems, roles, (preferred/understood) languages, locations, connected clients, user preferences, calendar activity, open tasks or assignments, topics of interest, contacts, and in particular feedback to messages and activities of the digital assistant system 300.

In some example embodiments, the digital assistant system 300 updates its context information from user activity information provided to the context manager 330 by the assistant service 310 and the conversation manager 320, as well as from notifications about third-party system activity obtained via the connection manager 360.

The context manager may provide API end points for the assistant service 310, the conversation manager 320, and the projection manager 340 to request or validate context information. In addition to the information provided from assistant service 310 and the conversation manager 320, the context manager 330 may request and receive relevant updates from external systems through the connection manager 360, and then uses this information to update its stored user context, leveraging the machine learning manager 380 to aggregate and re-organize its internal knowledge representations (e.g., to incorporate explicit and implicit user feedback, etc.). The context manager 330 leverages the semantics manager 370 to resolve semantic URIs for intra-communication within the digital assistant system 300.

In some example embodiments, the projection manager 340 is configured to act as the central coordinating unit connecting the actions of the digital assistant system 300 with user interactions. The projection manager 340 receives user requests from the conversation manager 320 in a structured, semantic format and coordinates the required actions with the action manager 350. The projection manager 340 may receive proactive data events from the action manager 350 and coordinate appropriate user notification and follow-up data actions with the conversation manager 320, as well as the action manager 350.

In some example embodiments, the projection manager 340 implements queues for administrating tasks that it receives from or hands off to one of the connected components, as mentioned previously. Queued tasks are continuously re-ranked according to priority. Taking into account a user's context (e.g., retrieved from the context manager 330), the projection manager 340 may decide to postpone or entirely discard execution of a task.

In some example embodiments, the projection manager 340 holds a repository of modularized and parametrizable plans that allow it to determine required follow-up actions upon receiving an event (e.g., from the action manager 350 as a result of an observed change in a KPI or from the conversation manager 320 as a result of a user request). In addition to explicit requests, implicit observations by the projection manager 340 (e.g., based on analysis of usage behavior) may also trigger invocations of plans.

In some example embodiments, the projection manager 340 interacts with the conversation manager 320 to trigger user notifications on the one hand and receive user requests on the other hand. It makes use of the context manager 330 and the semantics manager 370 to resolve a user's context as well as the relationship between semantic entities. The projection manager 370 invokes the action manager 350 to trigger execution of data processing and related tasks. It receives data events from the action manager 350 (e.g., in case of a significant change in a monitored KPI).

In some example embodiments, the projection manager 340 regularly calls the machine learning manager 380 to update its internal ranking mechanisms as well as its pattern detection mechanisms based on explicit and implicit user feedback data. Furthermore, the plans of the projection manager 340 can be updated(e.g., leveraging the machine learning manager 380) based on explicit and implicit feedback data, as well as based on updates to the semantic knowledge graphs, which may be managed by the semantics manager 370. In some example embodiments, the projection manager 340 is configured to act as a bridge between user interaction on the one hand and system actions (e.g., data processing) on the other hand. The projection manager 340 may build on pre-configured data processing pipelines (e.g., flows) and may be deeply integrated with tools that help identify and execute actions in given situations.

In some example embodiments, the action manager 350 is configured to orchestrate the transition from the semantic layer to the technical execution and data layers. The action manager 350 is configured to handle the execution of identified tasks, also referred to as action plans, as well as to trigger workflows. If certain pre-configured situations occur, such as a KPI exceeding a threshold or other situations of significant impact, the action manager 350 may invoke the projection manager 340 to request user interaction.

In some example embodiments, the action manager 350 maintains a catalog of modularized and parametrizable action plans stored in a structured format and including semantic information, such as semantic descriptions of the involved group of tasks, group of data objects, etc. Action plans may reference specific semantic requests across the connection manager 360, the semantics manager 370, and the machine learning manager 380. By way of the connection manager 360, action plans may reference external systems including their exposed data objects and API end points in a semantic fashion. In many cases, a plan may be a composition flow of plans spanning across different manager components. For instance, tasks of a plan regarding provisioning of data may be delegated to the connection manager 360, while tasks to apply machine learning inference (e.g. to predict, optimize, or explain) may be delegated to the machine learning manager 380. Certain calculations, such as aggregation of data, may be executed directly by the action manager 350.

Action plans can be configured for one-time execution or scheduled in a time- or event-based fashion. Furthermore, action plans may be triggered by external event subscriptions (e.g., social media posts, electronic calendar changes, etc.). Results of action plans may be assessed against configured criteria and raised to the projection manager 340 for further processing and assessment of follow-up actions if the corresponding criteria are met.

Besides pre-configured action plans, the action manager 350 may support creation of new action plans from existing templates and reusing existing modules, as well as from process mining. Besides manual, direct administration, creation of new action plans may be triggered by the projection manager 340 as a result of an explicit or implicit user request.

In some example embodiments, action plans of the action manager 350 are invoked either by internal scheduling mechanisms of the action manager 350, by events passed on or generated by the projection manger 340, or by external events, such as event subscriptions managed through the connection manager 360. Action plans may involve repeated, interchanging invocation of API end points of the projection manager 340, the connection manger 360, the semantics manager 370, and the machine learning manager 380. By way of the connection manager 360, plans may also involve invocation of (sub-)plans across different services and protocols (e.g., REST, OData, GraphQL, SOAP, etc.), systems (S/4HANA®, C/4HANA®, SAP SuccessFactors®, etc.), landscapes (e.g., SAP Cloud Platform, Microsoft Azure, Google Cloud, etc.) and flow engines.

In some example embodiments, the action manager 350 is configured to provide API end points to perform changes to its action plans or support creation of new action plans that are invoked by the projection manager 340. The action manager 350 may build on flow engines and data pipeline and leverage domain-specific, process-specific and data source-specific content of these platforms. In some example embodiments, the action manager extends existing frameworks by supporting cross-platform flows and a tight interconnection between design-time and run-time tasks. For example, a user can leverage a run-time object (e.g., execute an action plan) to modify or create a new design time object (e.g., create a new action plan) from existing building blocks. In combination with the projection manager 340, this facilitates the self-learning capabilities of the digital assistant system 300.

In some example embodiments, the connection manager 360 is configured to act as the single interface to all external data sources 395 connected to or made available to the digital assistant system 300. The connections manager 360 may feature parameterized requests to access, fetch and manipulate data via semantic URI requests. Furthermore, the connection manager 360 may support the creation and execution of monitoring jobs that regularly check one or several connected data sources for changes and notify other components of the digital assistant system 300 in such cases. If a data source 395 supports it, the connection manager 360 can also subscribe directly to a notification job run by the data source 395.

In some example embodiments, the connection manager 360 holds a catalog of configured data sources 395. Examples of data sources 395 include, but are not limited to, SAP systems, such as S/4HANA (e.g., both cloud and on premise systems), SAP Business Warehouse (BW), SAP Data Warehouse Cloud, SAP HANA DB and SAP Data Intelligence, as well as non-SAP systems, such as third-party data lakes (e.g., hosted on premise, or in the cloud) business applications, databases and collaboration/messaging tools (e.g., e-mail, electronic calendars, file shares, social media platforms, etc.). In addition, the connection manager 360 may provide access to publicly available sources of structured knowledge. Data access may be handled via REST APIs, OData Services/Core Data Services (CDS), or database queries, depending on the supported interfaces of the data source. For the particular case of linked data, the connection manager 360 can build SPARQL queries to tap into knowledge sources. The connection manager 360 may utilize the semantics manager 370 to translate semantic entities of requests to the connection manager 360 into technical data source names and parameters, and vice versa.

The connection manager 360 may leverage external tools, such as of SAP S/4HANA® Business Events, Situation Framework Events, SAP Enterprise Messaging or ABAP Push Channels to monitor data sources 395 for significant changes. The connection manager 360 may provide its own monitoring logic (e.g., managed as so-called monitoring plans) that allows to regularly request data from a data source and compare it against persisted data snapshots, or, where possible, references to data snapshots to assess whether changes occurred. Upon observing or being notified about such a change in a data source 395, the connection manager 360 may notify the component(s) of the digital assistant system 300 that have been configured in the monitoring plan about the incident. The notified component may then request the changed data set from the connection manager 360 or perform further actions.

In some example embodiments, the connection manager 360 provides API end points for configuration of monitoring jobs on connected data sources that are invoked by the action manager 350 and the context manager 330. Conversely, upon receiving a push event from an external system (e.g., through a configured monitoring job that has been handed off to a data source), the connection manager 360 may notify the action manager 350 and, respectively, the context manager 330.

In some example embodiments, the connection manager 360 provides end points for ad-hoc calls by the action manager 350, the context manager 330, the semantics manager 370, and the machine learning manager 380 to retrieve data or references to data from a connected system. Furthermore, the connection manager 360 may provide end points to manipulate data in connected systems that are relevant for the assistant service 310 and the action manager 350.

To enable interaction with other components of the digital assistant system 300 in a semantic fashion (e.g., via semantic references to data sources and parameters), the connection manager 360 interacts with the semantics manager 370 to resolve semantic references into technical references, and vice versa. In some example embodiments, the connection manager 360 provides a semantic access layer and content for a semantic integration of collaboration tools, such as e-mail and electronic calendar applications.

In some example embodiments, the semantics manager 370 is responsible for storage, administration and providing access to structured information of the digital assistant system 300 (e.g., its semantic knowledge). This information forms the basis of internal semantic communication of the digital assistant system 300, as well as its semantic user interaction (e.g., through the conversation manager 320).

In some example embodiments, information is stored in the semantics manager 370 in the form of knowledge graphs. The graphs may be implemented in Web Ontology Language (OWL). To facilitate management of knowledge across different contexts and domains, as well as maintainability, performance and reusability, the knowledge graphs within the semantics manager 370 may be modularized. Examples of categories of knowledge graphs that are stored within the semantics manager 370 include, but are not limited to, user-personal knowledge graphs, enterprise knowledge graphs, business domain-specific knowledge graphs, and generic knowledge graphs.

The semantics manager 370 may be used to obtain descriptive and attribute information for given semantic URIs, information about relations between URIs, as well as to retrieve related URIs, dimensions, influencers, or actions themselves for a given URI. In addition, the semantics manager 370 may implement a fuzzy search to determine relevant semantic URIs for given non-semantic keywords.

In some example embodiments, the semantics manager 370 receives evidence of new information from the conversation manager 320, as well as through the connection manager 360. The semantics manager 370 may store this evidence in an internal catalog and trigger the machine learning manager 380 in regular intervals to aggregate and re-organize its internal knowledge representations. From a machine learning perspective, the task of constructing knowledge graphs from unstructured data may be split into three subtasks: entity linking, collective classification, and link prediction. While entity linking is used to determine the nodes in the graph, disambiguate and map them to existing semantic concepts, node labels (e.g., attributes) may be derived using collective classification. The relationships between the extracted entities may be derived using link prediction. Probabilistic models may be used to predict those relations, although embedding based models may lead to better generalizability and scalability in some cases.

In some example embodiments, the semantics manager 370 supports the conversation manager 320 in interpreting and extracting semantic URIs in business context. Furthermore, the knowledge graphs of the semantics manager 370 are used by the context manager 330, the projection manager 340, the action manager 350, the connection manager 360, and the machine learning manager 380 to resolve semantic URIs used for inter-component communication.

In some example embodiments, the semantics manager 370 leverages the machine learning manager 380 to request updates of its internal knowledge representations and incorporation of collected evidence into these knowledge representations by use of machine learning models.

In some example embodiments, the machine learning manager 380 provides the infrastructure to organize invocation (e.g., model inference or model consumption), preparation (e.g., model training, model update, or information extraction in general) and lifecycle management of machine learning and complex analytical models. The machine learning manager 380 may be used to enable intelligent capabilities of the digital assistant system 300 that rely on computationally expensive and/or analytically complex tasks, such as machine learning (e.g., ranging from simple statistical inference to deep neural networks), simulation, reasoning, and optimization tasks. The prescriptive, self-learning, and simulation capabilities of the digital assistant system 300 are enabled by the machine learning manager 380. Other capabilities, such as aggregation, self-explaining, knowledge base, context-awareness, and personalization may also be realized leveraging the machine learning manager 380.

In some example embodiments, the machine learning manager 380 comprises machine learning and analytics models, which may be executed directly within the machine learning manager 380, as well as models that are hosted and executed on external compute infrastructures and accessed by the machine learning manager 380 through APIs. The latter group includes black-box and third-party models. Besides model training and model invocation, the machine learning manager 380 may include lifecycle management for machine learning and analytical models, as well as capabilities for bi-directional translation between semantic data access and structured input data formats required by machine learning and analytical models.

In some example embodiments, the machine learning manager 380 is structured into three major sub-components. The first sub-component, model catalog, organizes semantic translation, data access and model lifecycle management. In particular, it keeps a catalog of deployed models, model versions, model specifications (e.g., semantic inputs, semantic outputs, data sources, external model services, etc.), logs and results of recent model preparation and invocation runs, model statistics, and tenant-/user-/context-specific configuration. The second sub-component, model preparation, wraps all functionality regarding initial training, performance assessment and update of machine learning and analytical models. In particular, it allows re-training of machine learning models based on external triggers (e.g., through the action manager 350, upon observing a significant change in input data) as well as scheduled re-training based on an internal monitoring of model performance. Model preparation is executed directly within the machine learning manager 380 in some cases, but may be handed down to third-party machine learning or analytical services in other cases, where high-quality models for a specific purpose or domain exist. The third sub-component, model invocation, wraps all functionality that is required to calculate/trigger predictions, classifications, anomaly detections, explanations, and recommendations by means of invoking machine learning and/or analytical models. As in the case of model preparation, the actual execution of the machine learning or analytical model is done within the machine learning manager 380 in some cases and handed down to encapsulated third-party-provided models in other cases.

In some example embodiments, the machine learning manager 380 provides generic API end points for the action manager 350 to invoke machine learning and analytical models, and consume their results, in a semantic, model-agnostic fashion. The action manager 350 can also trigger model preparation jobs, for example, as a configured action of an action plan that is triggered by an observed change in a monitored data object. In addition, the conversation manager 320, the projection manager 340, the context manager 330, and the semantics manager 370 may interact with the machine learning manager 380 to trigger re-training jobs of their internal models and to retrieve the resulting models after completion, for internal usage. The machine learning manager 380 may leverage the semantics manager 370 to resolve semantic URIs. The machine learning manager 380 may leverage the connection manager 360 to request required enterprise and third-party data for model training and model invocation jobs, and to trigger execution of “satellite” machine learning models in external systems.

In some example embodiments, the machine learning manager 38 provides a mapping framework between domain-specific semantic entities in the enterprise context on the one end and parameterizations and structured data inputs of machine learning and analytical models on the other end. All models may feature self-explaining capabilities that are referenceable by the respective semantic entities. These self-explaining capabilities are realized by leveraging both, built-in explanation features of machine learning models, as well as by use of surrogate models. The machine learning manager 380 aims at a deep integration (e.g., embedding) of machine learning models in all enterprise contexts and therefore supports a “bring-your-own-model” paradigm, which allows to make use of best-of-breed models that are tailored for optimal performance on a specific domain and are made accessible by the digital assistant system 300 via use of dedicated wrapper/integration procedures, thereby enabling the leveraging of domain-specific analytical models that go beyond mere prediction use cases and support simulation of business situations and decisions by exposing dedicated manipulator variables. Optimization algorithms can be used to find optimal configurations of these manipulator variables in order to maximize/minimize specific business KPIs.

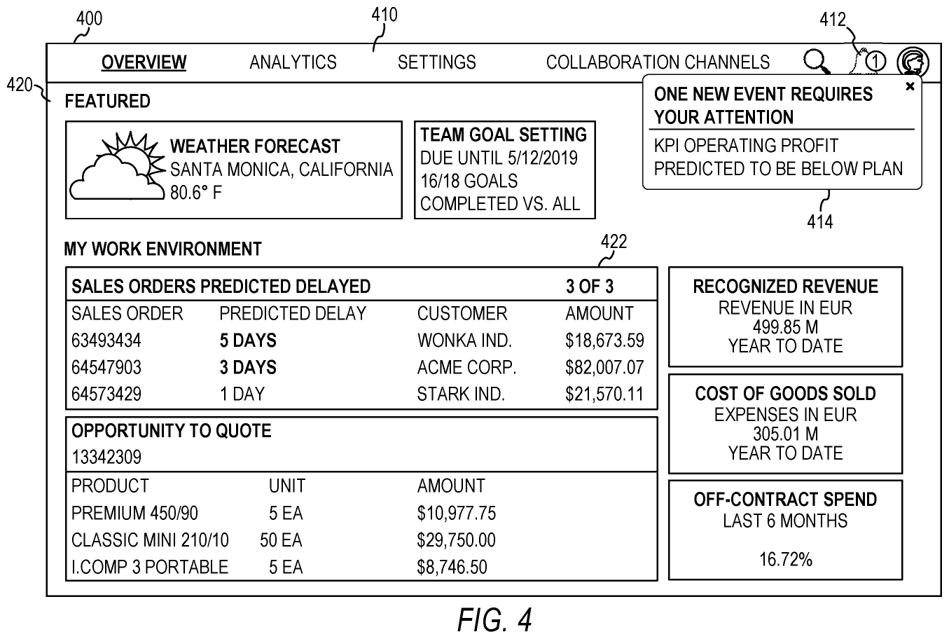

FIGS. 4-11 illustrate a graphical user interface (GUI) 400 of a digital assistant, in accordance with some example embodiments. In some example embodiments, the GUI 400 is displayed on a computing device of a user via the front-end application 305. In FIG. 4, the GUI 400 comprises a menu bar 410 and a page body area 420. The menu bar 410 may comprise selectable menu options corresponding to different operations that the user may want to perform, such as requesting analytics, configuring settings, and loading a collaboration channel to collaborate with one or more other users.

In some example embodiments, the menu bar 410 comprises a notification user interface element 412 configured to provide an indication when an event arises. For example, when an event is issued by the digital assistant system 300, the notification user interface element 412 may provide a visual notification indicating the event, such as a number being displayed over an icon in order to indicate how many events are awaiting review by the user. The user may select (e.g., click on or tap) the notification user interface element 412 to find out more information about the event. For example, in FIG. 4, in response to the user selecting the notification user interface element 412, another user interface element 414 is displayed, such as in the form of a pop-up element overlaying the page body 420. The other user interface element 414 comprises information about the event, such as a brief explanation of the event (e.g., “KPI OPERATING PROFIT PREDICTED TO BE BELOW PLAN” in FIG. 4). The user may select the other user interface element 414 to find out more details about the event. While the page body 420 is displaying certain information 422, the selection of the user interface element 414 may cause the digital assistant system 300 to replace content of the menu bar 410 and the page body 420 with content additional user interface features configured to enable the user to interact with the digital assistant system 300 regarding the event based on the user selection of the other user interface element 414.

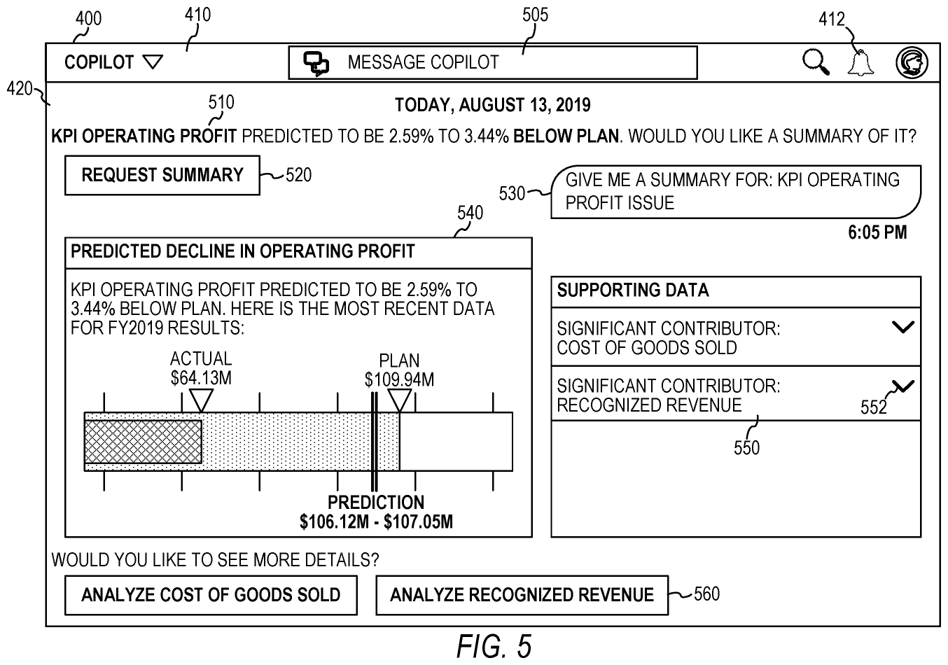

In FIG. 5, the GUI 400 has been reconfigured in response to the user's selection of the other user interface element 414. As a result, the menu bar 410 includes a user interface element 505 (e.g., a text field) configured to receive a message from the user directed to the digital assistant system 300. The user may use the user interface element 505 to request that certain operations be performed and to ask the digital assistant system 300 questions to be answered. In FIG. 5, the page body 420 displays another indication 510 of the event. This indication 510 may also prompt the user to view a summary of the event (e.g., “WOULD YOU LIKE A SUMMARY OF IT?”), and a corresponding selectable user interface element 520 may also be displayed to receive a user instruction to provide a summary of the event. The user may also provide audio input (e.g., a verbal utterance) to provide the instruction. In response to the user instruction, the digital assistant system 300 displays a visual indication 530 of the user instruction, as well as the summary 540 that was requested by the user. The summary 540 may provide more in-depth details regarding the event, such as underlying KPIs. In addition to the summary 540, the digital assistant system 300 may display data supporting the summary, such as factors contributing to the event. Indications 550 of the factors may be displayed along with corresponding selectable user interface elements 552 configured to trigger a display of details about the supporting data in response to their selection. For example, in response to the selection of the selectable user interface element 552 corresponding to “SIGNIFICANT CONTRIBUTOR: COSTS OF GOODS SOLD” in FIG. 5, or in response to a suitable textual or verbal user input, the digital assistant system 300 displays more detailed information 654 about how the costs of goods sold is a significant factor in the predicted decline in operating profit.

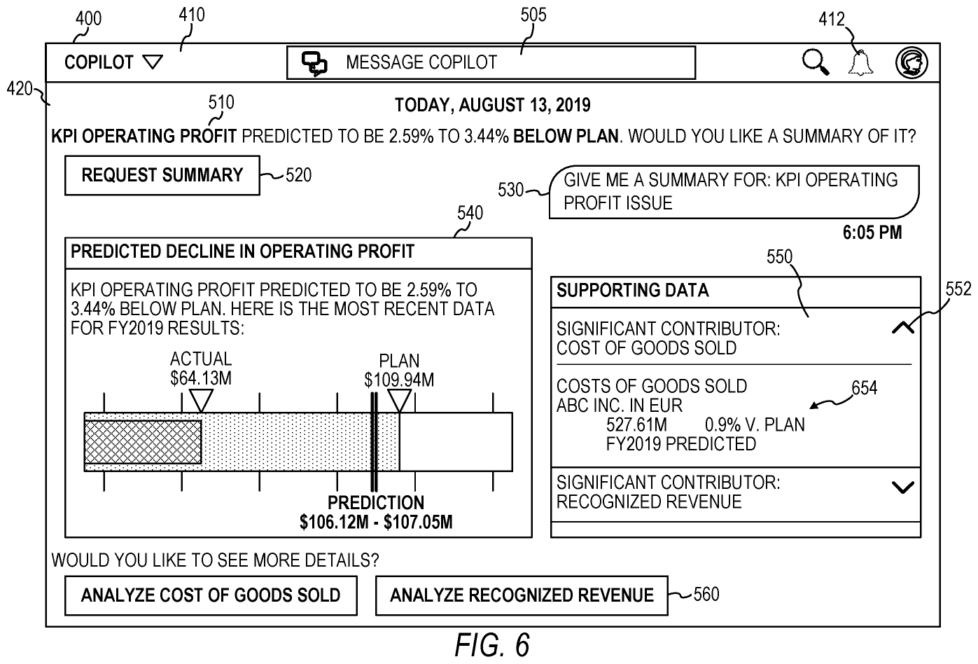

The digital assistant system 300 may also display one or more selectable user interface elements 560 configured to trigger presentation of additional analysis regarding particular aspects of the factors for the prediction. For example, as seen in FIGS. 5 and 6, corresponding selectable user interface elements 560 are displayed for the user to request analysis of the cost of goods sold and analysis of the recognized revenue. In response to the selection of one of the selectable user interface elements 560, the digital assistant system 300 may perform drill down operations to generate and display a detailed explanation of one or more aspects of the event. For example, in response to the selection of the selectable user interface element 560 corresponding to the cost of goods sold in FIG. 6, the digital assistant system 300 displays a visual indication 730 of the user instruction, as well as the detailed explanation 740 that was requested by the user. Additionally, indications 750 of data supporting the detailed explanation 740, along with corresponding selectable user interface elements 752 configured to trigger display of the supporting data 754, may also be displayed concurrently with the detailed explanation 740.

In some example embodiments, the digital assistant system 300 generates a recommendation for addressing the event (e.g., a recommendation on how to avoid the predicted increase in cost of goods sold) and prompts the user to select a selectable user interface element 760 to trigger the presentation of the recommendation. In addition to selectable user interface elements, the digital assistant system 300 may receive user instruction via textual or verbal input as well. In response to the selection of the selectable user interface element 760 corresponding to a request for a recommendation, or some other type of corresponding user instruction, the digital assistant system 300 displays a visual indication 770 of the user instruction, as well as a recommendation 780 for addressing the event. Additionally, indications 790 of data supporting the recommendation 780, along with corresponding selectable user interface elements 792 configured to trigger display of the supporting data 794, may also be displayed concurrently with the recommendation 780.

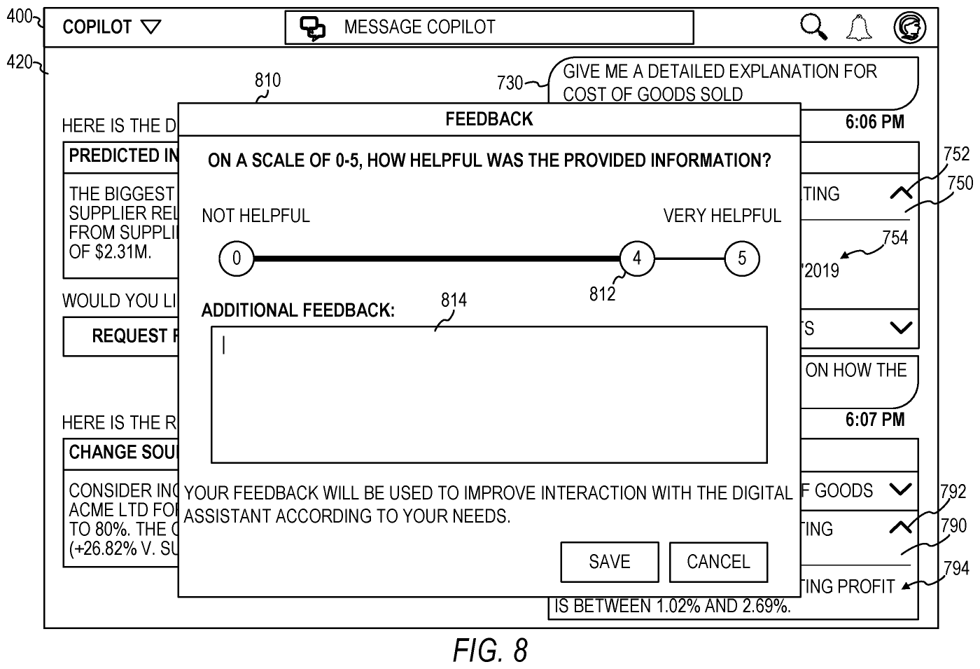

At any point during an interaction of a user with the digital assistant system 300, the user can give feedback to the digital assistant system 300. This feedback can be provided in textual or verbal form, but also through clicking on a feedback buttons or other selectable user interface elements in each of the control elements of the user interface (e.g., rectangular boxes, such as “predicted increase in cost of goods sold”, etc.). In some example embodiments, the digital assistant system 300 requests feedback from the user regarding the information provided to the user, such as the summary, the supporting data for the summary, the detailed explanation, the supporting data for the detailed explanation, the recommendation, and the supporting data for the recommendation. For example, in FIG. 8, the digital assistant system 300 displays a user interface element 810, such as a pop-up window overlaying the page body 420. The user interface element 810 comprises one or more other user interface elements 812 and 814 configured to receive input from the user regarding the level of helpfulness of the information provided by the digital assistant system 300 to the user. For example, the user interface element 812 may comprise a slider element configured to enable the user to provide a numerical value for the level of helpfulness, and the user interface element 814 may comprise a text field configured to receive text-based input regarding the helpfulness. The user may also provide binary feedback (e.g., “This was helpful,” “This was not helpful”), as well as three-valued or trinary feedback (e.g., “This was helpful,” “This is not interesting,” “This is wrong”).

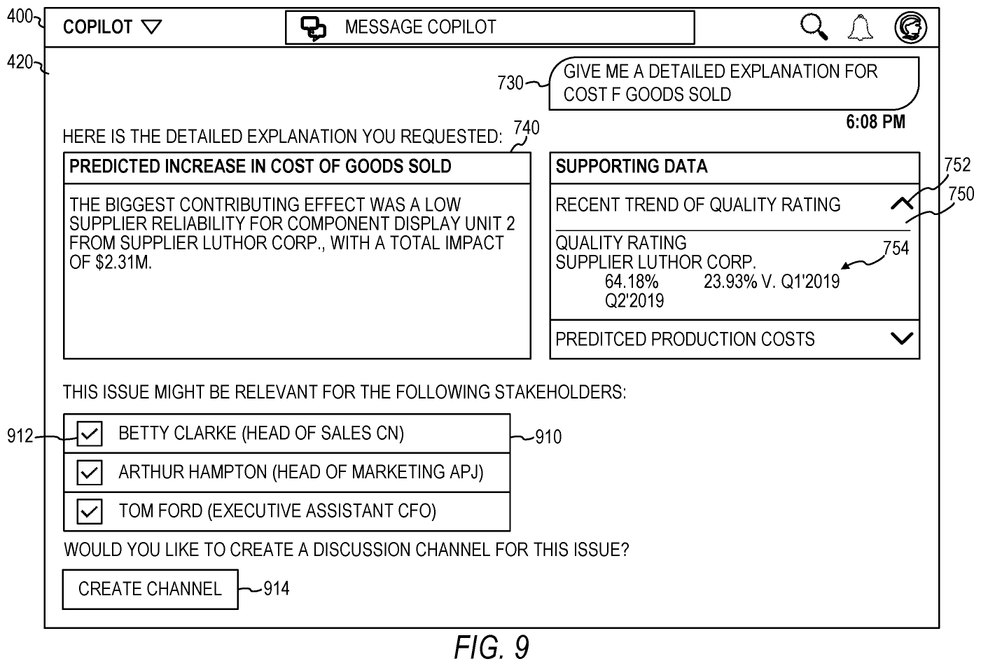

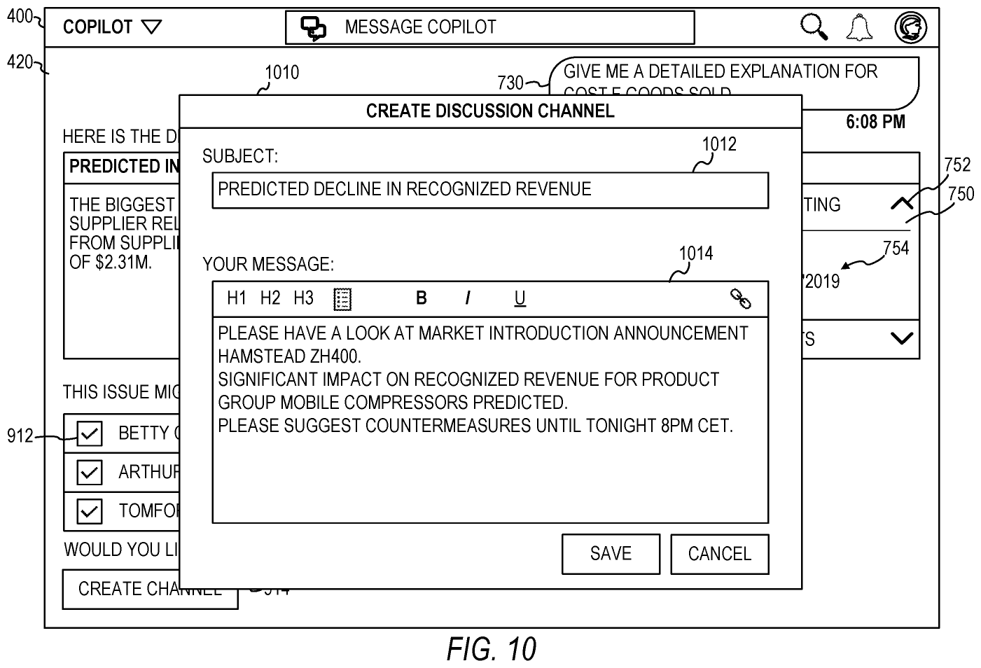

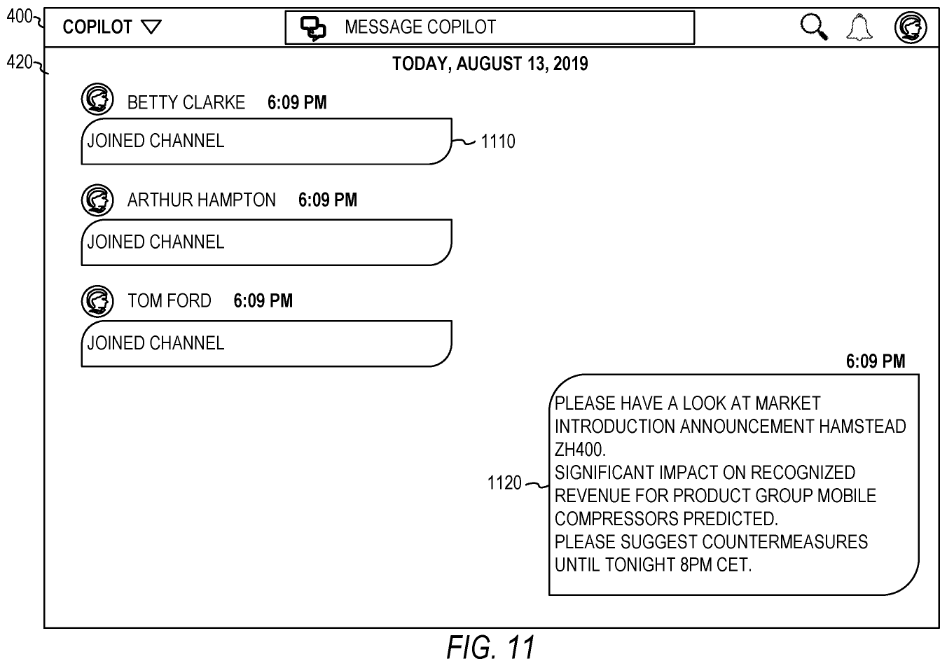

In FIG. 9, the digital assistant system 300 provides the user with the ability to create a discussion channel for the event. The digital assistant system 300 determines other users to whom the event might be relevant and displays indications 910 of the other users along with corresponding selectable user interface elements 912 configured to enable the user to select which other users to include in the discussion channel. In response to a user selection of a selectable user interface element 914 that is configured to instruct creation of the discussion channel, the digital assistant system 300 triggers a creation process for the discussion channel. For example, in FIG. 10, the user has selected the selectable user interface element 914 in FIG. 9 to create the discussion channel, and the digital assistant system 300 has responded to this user selection by displaying a user interface element 1010, such as a pop-up window overlaying the page body 420. The user may use the user interface element 1010 to provide a subject heading for the discussion channel, such as via a text field 1012, and to provide a message to the other users that are to be invited to join the discussion channel, such as via a text field 1014. In some example embodiments, both the subject heading and the message are automatically generated by the digital assistant system 300 as a summary of or in reaction to the issue event at hand by way of AI-powered natural language generation. The text fields 1012 and 1014 may be auto-populated with the automatically generated subject heading and message. In FIG. 11, the digital assistant system 300 has created the discussion channel based on the instruction by the user. The content of the discussion channel may be displayed in the page body 420. This content may include, but is not limited to, the current date, messages 1110 from other uses, and messages 1120 from the user that requested creation of the discussion channel, along with corresponding time stamps for the messages.

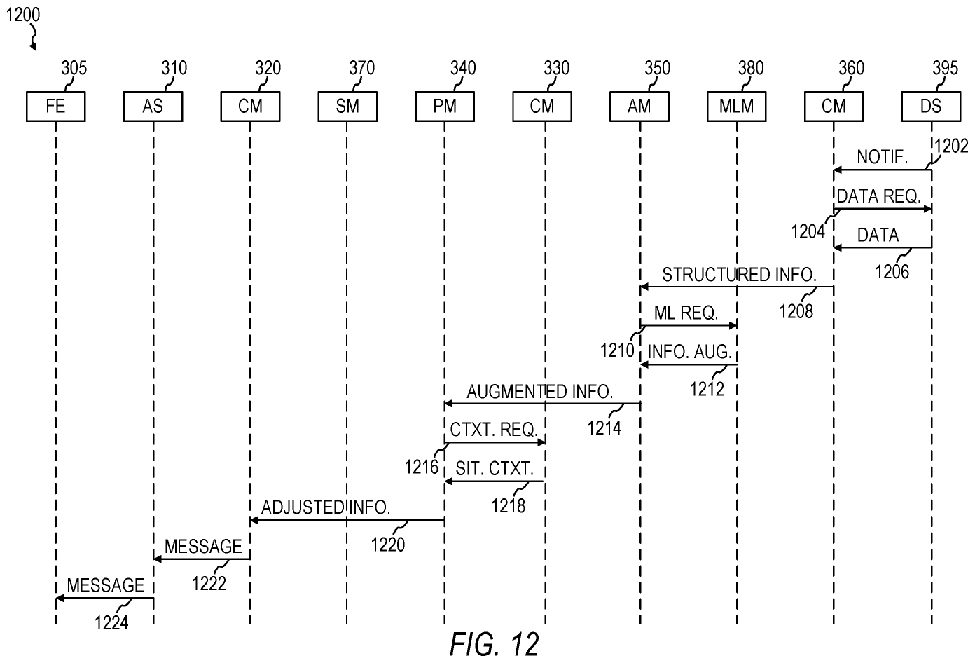

FIG. 12 illustrates a proactive user notification flow 1200, in accordance with some example embodiments. The proactive user notification flow 1200 can be performed by processing logic that can comprise hardware (e.g., circuitry, dedicated logic, programmable logic, microcode, etc.), software (e.g., instructions run on a processing device), or a combination thereof. In one example embodiment, one or more of the operations of the flow 1200 are performed by the digital assistant system 300 of FIG. 3, or any combination of one or more of its components, is implemented as described above.

The proactive user notification flow 1200 shows a proactive user notification being triggered by an event of a data change. Here, the data change in an external data source 395 that is connected to the connection manager 360 triggers the execution flow. Such a data change may, for example, have been observed by the data source 395 and then pushed to the connection manager 360, at operation 1202. Alternatively, the flow 1200 may also be triggered by a change in a data object that is on the list of objects to be monitored, which may be stored by the connection manager 360. Upon observing and initially assessing the data change, the connection manager 360 requests additional relevant data, at operation 1204, which is provided by the data source 395 to the connection manager 360, at operation 1206, and the connection manager 360 passes on this information to the action manager 350, at operation 1208.

Based on a notification from the connection manager 360 about the data change event, one or more plans of the action manager 350 are invoked that may trigger further data analysis and/or augmentation steps, such as by the action manager 350 requesting and receiving such data analysis and/or augmentation operations from the machine learning manager 380, at operations 1210 and 1212. Once a data event suitable for presentation to the user is available, it is pushed to the projection manager 340, at operation 1214. The projection manager 340 requests and receives the current situation context from the context manager 330, at operations 1216 and 1218, and then determines if and when to inform the user. At a suitable point in time, the projection manager 340 identifies an active conversation dialog to which the incoming message fits, and then forwards the data event to the conversation manager 320, at operation 1220. The conversation manager 320 creates a human-readable dialog message and transmits the message to the assistant service 310, at operation 1222. The assistant service 310 transmits a corresponding notification to the relevant connected front end client application(s) 305 (e.g., a user's notification bar) to inform the user, at operation 305.

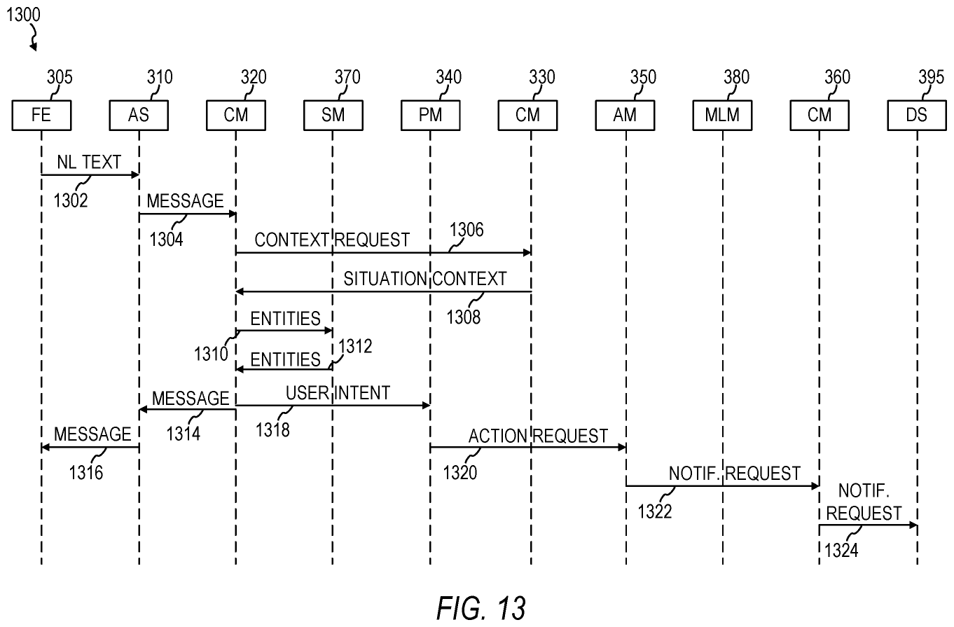

FIG. 13 illustrates a user-requested processing flow 1300, in accordance with some example embodiments. The user-requested processing flow 1300 can be performed by processing logic that can comprise hardware (e.g., circuitry, dedicated logic, programmable logic, microcode, etc.), software (e.g., instructions run on a processing device), or a combination thereof. In one example embodiment, one or more of the operations of the flow 1300 are performed by the digital assistant system 300 of FIG. 3, or any combination of one or more of its components, is implemented as described above.

The user-requested processing flow 1300 shows the processing of a user-initiated request. Via a dialogue system of a front-end application 305 of the digital assistant system 300, a user requests in natural language to have the digital assistant system 300 monitor a specific KPI (e.g., operating profit) and inform the user about critical deviations. The natural language message is received by the assistant service 310, at operation 1302, and routed to the conversation manager 320, at operation 1304, for analysis. The conversation manager 320 leverages the user's situational context, which is requested and received from the context manager 330, at operations 1306 and 1308. The conversation manager 320 also makes use of the semantics manager 370, at operations 1310 and 1312, to resolve the user's specific request. The conversation manager confirms, via the assistant service 310 and the front-end application 305, to the user that it has understood their intent, at operations 1314 and 1316, and, in parallel, passes the semantically resolved and structurally extracted request data on to the projection manager 340, at operation 1318. The projection manager 340 transmits the user request to the action manager 350, at operation 1320, to set up an appropriate plan to monitor the requested KPI. The action manager 350 subscribes to changes of the requested entity or schedules own monitoring jobs to probe the requested source for changes via the conversation manager 360 and the data source(s) 395, at operations 1322 and 1324. Upon observing a significant data change, as requested by the user, a notification flow, such as the proactive user notification flow 1200, is triggered.

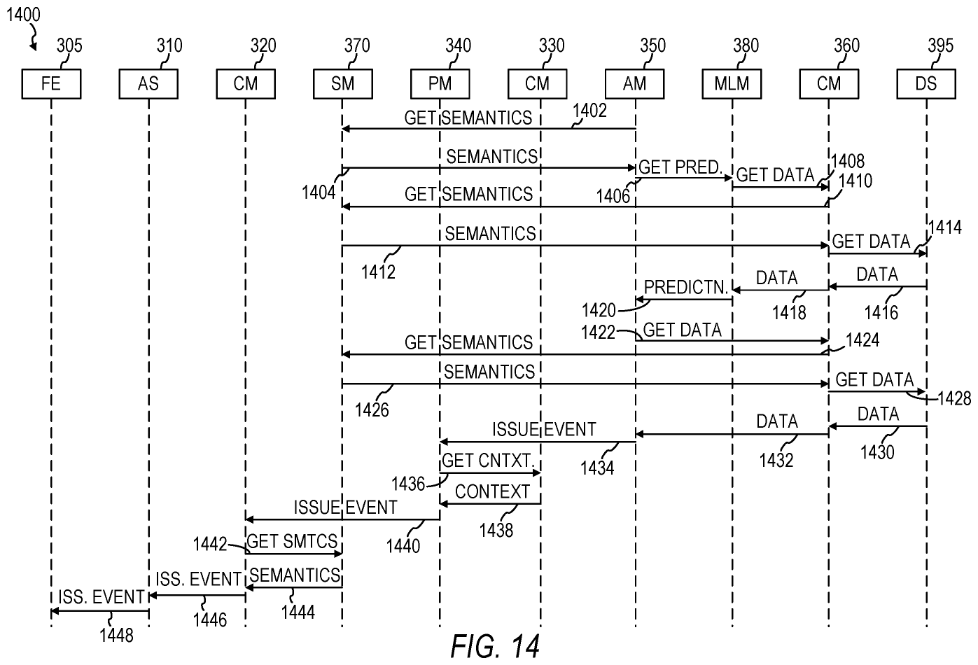

FIG. 14 illustrates a summary pattern flow 1400, in accordance with some example embodiments. The summary pattern flow 1400 can be performed by processing logic that can comprise hardware (e.g., circuitry, dedicated logic, programmable logic, microcode, etc.), software (e.g., instructions run on a processing device), or a combination thereof. In one example embodiment, one or more of the operations of the flow 1400 are performed by the digital assistant system 300 of FIG. 3, or any combination of one or more of its components, is implemented as described above.

The summary pattern flow 1400 addresses a situation in which a user requests to receive a brief summary whenever a particular situation occurs. The actual summary pattern flow 1400 starts with an event of type “issue” that is raised by the action manager 350 in response to it observing a significant deviation between predicted and planned value of the KPI operating profit or some other particular event. Such an event is preceded by a scheduled monitoring routine. The action manager 350 regularly calls the semantics manager 370, at operation 1402, to retrieve detailed information about monitored KPIs. This information is returned, at operation 1404, and may include aspects such as the KPIs target (e.g., whether the business aims to minimize the KPI (e.g., costs) or maximize the KPI (e.g., revenues), as well as calculation formulas and influencing KPIs. A KPI such as operating profit may be calculated by an aggregation of multiple underlying KPIs, such as operating expenses and recognized revenue. KPIs that are at the bottom of the calculation hierarchy are referred to as leaf KPIs.

After having received this information, the action manager 350 requests a prediction for each leaf KPI by calling the machine learning manager 380 in a semantic fashion, at operation 1406. The machine learning manager 380 itself calls the connection manager 360, at operation 1408, to retrieve the actual data for the KPI that it has been requested to predict, and the connection manager 360, in turn, calls the semantics manager 370, at operation 1410, which returns the corresponding semantics, at operation 1412. The connection manager 360 uses the returned semantics to derive the required data source and dimensions. The derived data source and dimensions are then used by the connection manager 360 to retrieve the actual data for the KPI from the data source 395, at operations 1414 and 1416, and the retrieved data is then transmitted to the machine learning manager 380, at operation 1418.

The data ultimately obtained by machine learning manager 380 is then used by the machine learning manager 380 as input for a linear regression model that generates a prediction. The machine learning manager 380 sends the prediction to the action manager 350, at operation 1420, and persists a reference to the prediction and its underlying data for later retrieval (e.g., when an explanation is requested). In parallel to the prediction, the action manager 350 requests the plan and actual values for every relevant KPI from the connection manager 360, at operation 1422. Again, the connection manager 360 resolves the semantic URI, first leveraging the semantics manager 370, at operations 1424 and 1426, before it is able to return the requested data from the data source 395 to the action manager 350, at operations 1428, 1430, and 1432. Based on those values, the action manager 350 compares planned values against predicted values for the requested KPI (e.g. operating profit). If there is a deviation that exceeds a predefined threshold, then the action manager 350 raises an event of type “issue” at operation 1434. In addition, the action manager 350 also calculates proactively which deviation of lower-level KPIs (e.g. according to its calculation tree) led to the deviation of the monitored KPI, in preparation for a guided drill down pattern.

Once the “issue” event is raised, the action manager 350 propagates this event to the projection manager 340, at operation 1434. The projection manager 340 predicts the relevance of the event for the affected user, given the user's context that is requested and received from the context manager 330, at operations 1436 and 1438. If the event is classified as relevant, then it gets passed on to the conversation manager 320, at operation 1440.

The conversation manager 320 parses the event object received from the projection manager 340 to extract the intents (e.g. summary for the user) and entities (e.g. financial KPIs and chart types). The semantics manager 370 is called to receive further properties and values related to the extracted entities, such as friendly names, at operations 1442 and 1444. Those properties and values are then stored for later enrichment of the dialog with the user. After receiving the results from the semantics manager 370, the conversation manager 320 adds the extracted entities to the conversational memory of the bot, and the appropriate bot skill is triggered. This is done by mapping the data event to an intent utterance, which is sent to the conversational AI unit 390. As a result, the conversational AI unit 390 starts the skill summarization, parses the conversational memory for all required entities, and finally sends back a message that was predefined within the skill.

After the message has been received by the conversation manager 320, it is enriched with additional data, which may include augmenting the text with the data previously retrieved from the semantics manager 370, adding message metadata and charting instructions for the front-end application 305. Once the message postprocessing is completed, it gets passed on to the assistant service 310, at operation 1446, which forwards it directly to the front-end application 305, at operation 1448. The user interface of the front-end application 305 notifies the user about the situation, such as by bringing up a notification pop-up element or some other type of graphical user interface element. Once the user enters the emulated user interface by clicking on the notification, the user interface renders the message and the charts as defined by the charting instructions, which ensures that the summary is presented in a visually appealing way to the user.

While this summary might be sufficient to get a first indication of the type and the severity of the business situation, user might want to drill deeper into the details to understand the root causes. In contrast to classical analytical applications where the user would be required to manually drill down into every dimension to look for hidden patterns and root causes, the guided drill down feature of the digital assistant system 300 proactively proposes the relevant drill down dimensions to the user.

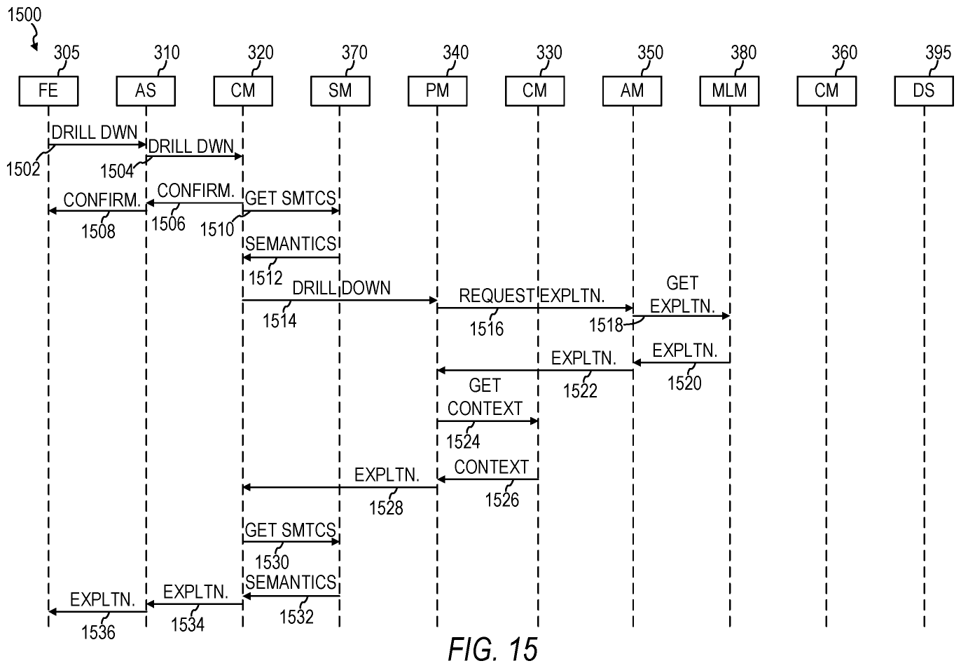

FIG. 15 illustrates a guided drill down pattern flow 1500, in accordance with some example embodiments. The guided drill down pattern flow 1500 can be performed by processing logic that can comprise hardware (e.g., circuitry, dedicated logic, programmable logic, microcode, etc.), software (e.g., instructions run on a processing device), or a combination thereof. In one example embodiment, one or more of the operations of the flow 1500 are performed by the digital assistant system 300 of FIG. 3, or any combination of one or more of its components, is implemented as described above.

Jointly with the summary, the front-end application 305 offers the user the possibility to drill down into leaf KPIs that were identified as being responsible for the reported issue with the monitored KPI. In the prototype implementation the list of proposed leaf KPIs consists of all leaf KPIs whose predictions deviated significantly from the planned value. Once the user clicks on one of the provided buttons or asks the bot to drill down into one of the leaf KPIs, the utterance (e.g., “drill down into recognized revenue”) is sent from front end application 305 to the assistant service 310, at operation 1502, which routes the text to the conversation manager 320, at operation 1504.

When a user requests to drill into a leaf KPI, this request triggers the digital assistant system 300 to investigate reasons that might explain the deviation of that KPI. As this task can be computationally rather intensive (e.g., if simulations need to be performed), it may be processed asynchronously. To allow the user to continue the conversation in the meantime, the conversation manager 320 returns an informative confirmation message (e.g., “Ok, I will try to get some more insights into KPI recognized revenue”) to the front-end application 305 via the assistant service 310, at operations 1506 and 1508.

At the same time, the conversation manager 320 forwards the utterance to the conversational AI unit 390 via the semantics manager 370, at operation 1510 and 1512. The response is then parsed into an event object that is forwarded to the projection manager 340, at operation 1514. The projection manager 340 adds the event to its queue. When eventually processing the task, the projection manager 340 sends a request to the action manager 350, at operation 1516, to execute its ad-hoc plan for deriving an explanation. The action manager 350 requests explanations by calling the corresponding service provided by the machine learning manager 380. The action manager 350 passes along an identification to the machine learning manager 380 that uniquely identifies the original prediction from the preceding summary step, at operation 1518. From this identification, the machine learning manager 380 restores the original prediction model and the corresponding input data. Based on this input data, long and short-term impacts are determined for the leaf KPI. As a result, the machine learning manager 380 returns a list of impact factors as well as their absolute monetary impact in the target currency (e.g., EUR), at operation 1520.

The action manager 350 then sends these results to the queue of the projection manager 340, at operation 1522. The projection manager 340 again ranks the relevance of the task and eventually forwards the result the conversation manager 320, at operation 1528. Analogously to the summary pattern, the conversation manager 320 extracts intent and entities and calls the conversational AI unit 390 with a corresponding utterance (e.g., “provide explanation for recognized revenue”) via the semantics manager 370, at operations 1530 and 1532. The message is then enriched with additional information again before being sent to the assistant service 310, at operation 1534. The assistant service 310 forwards the message to the front end application 305, at operation 1536, where the emulated user interface renders the text and graphics as defined by the message object.

After the root cause of the deviation, or other event, has been detected, users of the digital assistant system 300 may want to solve the situation by performing effective countermeasures. To this end, the digital assistant system 300 recommends actions, if applicable.

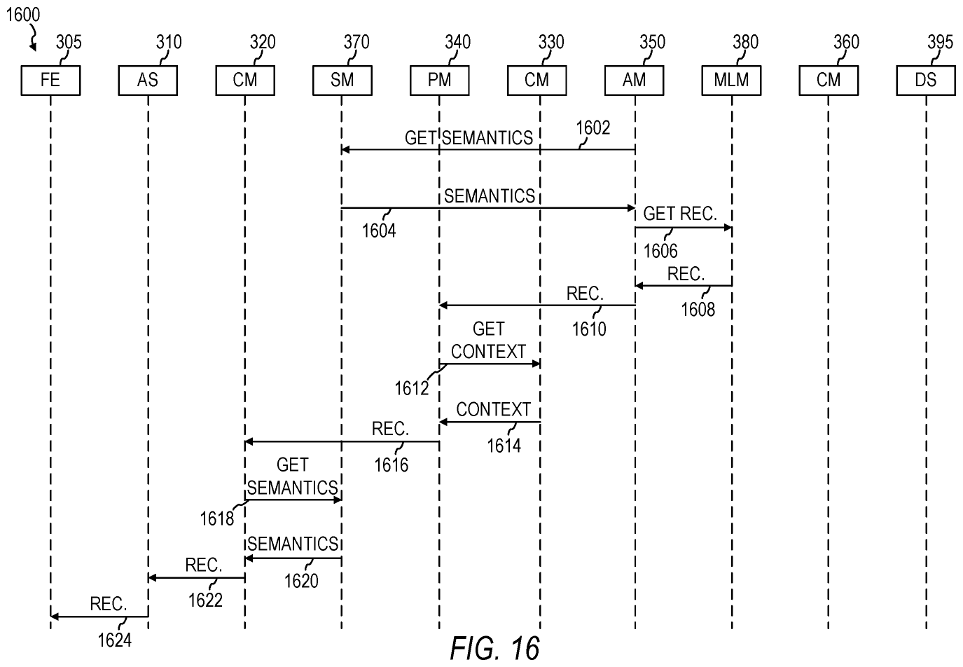

FIG. 16 illustrates a recommendation pattern flow 1600, in accordance with some example embodiments. The recommendation pattern flow 1600 can be performed by processing logic that can comprise hardware (e.g., circuitry, dedicated logic, programmable logic, microcode, etc.), software (e.g., instructions run on a processing device), or a combination thereof. In one example embodiment, one or more of the operations of the flow 1600 are performed by the digital assistant system 300 of FIG. 3, or any combination of one or more of its components, is implemented as described above.

In some example embodiments, the digital assistant system 300 provides proactive suggestion of recommendations to a user, when available. To realize this feature, the recommendations may already be requested by the action manager 350 as soon as it completes the explanation task. Thus, the recommendation pattern may start directly after the action manager 350 sent the explanation result object to the projection manager 340.

The action manager 350 calls the semantics manager 370, at operation 1602, to retrieve additional semantical information for the leaf KPI for which the recommendation is requested. The additional semantical information is returned from the semantics manager 370, at operation 1604. Analogous to the explanation pattern, the action manager 350 then requests a recommendation by calling the corresponding service provided by the machine learning manager 380, at operation 1606. The machine learning manager 380 implements some predefined actions for specific leaf KPIs. Thus, depending on the leaf KPI, either a predefined action will be performed, or an empty result set will be returned in case no suitable action could be determined. The predefined actions may cover an optimization task that tries to find the best supplier, and an anomaly detection task that looks for anomalies in product configurations (e.g., materials without general agreement in place). In some example embodiments, the recommendation to switch the supplier of a certain material or to create a general agreement for a certain product material is returned. In addition, the machine learning manager 380 may implement functionalities to do what-if analysis that simulates the impact of following a given recommendation.

When a recommendation was found, it is returned, along with the simulated impact, from the machine learning manager 380 to the action manager 350, at operation 1608. The impact received by the action manager 350 is then aggregated following the KPI hierarchy up to the monitored KPI using interval arithmetic. Besides the recommendation, the action manager 350 also requests the original prediction for each leaf KPI. This information, together with the plan and actual values, which are requested from the connection manager 360, and additional metrics, which are calculated based on those values, are passed on to the projection manager 340, at operation 1610.

The remaining operations 1612, 1614, 1616, 1618, 1620, 1622, and 1624 are identical to the corresponding steps 1524, 1526, 1528, 1530, 1532, 1534, and 1536 from the guided drill down pattern flow 1500. The projection manger 340 ranks task and forwards the event object to the conversation manager 320 once it is classified as relevant. The conversation manager 320 extracts intent and entities and calls the conversational AI unit 390, via the semantics manager 370, with a corresponding utterance (e.g. “provide recommendation for recognized revenue”). The message is then enriched with additional information once more, before it is sent to assistant service 310. The assistant service 310 finally forwards the message to the front-end application 305, where the emulated user interface renders the text and graphics as defined by the message object.

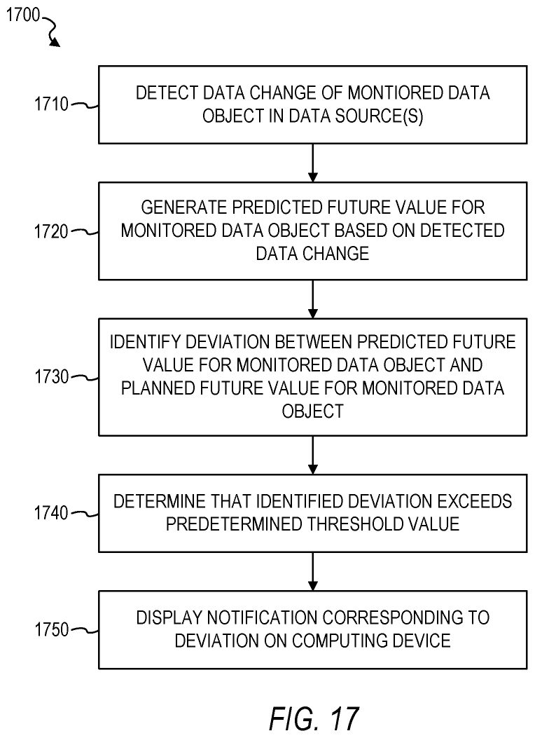

FIG. 17 is a flowchart illustrating a method 1700 of implementing a digital assistant that provides proactive notifications to users, in accordance with some example embodiments. The method 1700 can be performed by processing logic that can comprise hardware (e.g., circuitry, dedicated logic, programmable logic, microcode, etc.), software (e.g., instructions run on a processing device), or a combination thereof. In one example embodiment, one or more of the operations of the method 1700 are performed by the digital assistant system 300 of FIG. 3, or any combination of one or more of its components, is implemented as described above.

At operation 1710, the digital assistant system 300 detects a data change in one or more data sources, the data change corresponding to a monitored data object. At operation 1720, the digital assistant system 300 generates a predicted future value for the monitored data object based on the detected data change. At operation 1730, the digital assistant system 300 identifies a deviation between the predicted future value for the monitored data object and a planned future value for the monitored data object. At operation 1740, the digital assistant system 300 determines that the identified deviation exceeds a threshold value. At operation 1750, the digital assistant system 300 causes a notification corresponding to the deviation to be displayed on a computing device based on the determination that the identified deviation exceeds the threshold value. In some example embodiments, rather than using a threshold value to determine whether or not to provide a notification to the user, the digital assistant system 300 applies a data-dependent algorithm to the detected data change, the predicted future value, as well as other related data in combination. The outcome of this algorithm determines whether or not, as well as how, the notification is pushed to the user. The data-dependent algorithm may be a trained machine learning model learned from data, such as user behavior data and user preference data. In some example embodiments, the notification corresponding to the deviation is caused to be displayed based on any combination of one or more of: a role of a user of the computing device, one or more characteristics of the computing device, one or more upcoming meetings identified from an electronic calendar of the user of the computing device, and one or more previous conversations between a user of the computing device and a digital assistant.

It is contemplated that any of the other features described within the present disclosure can be incorporated into the method 1700.

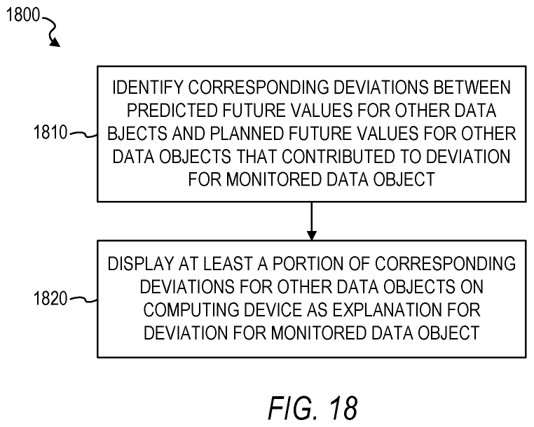

FIG. 18 is a flowchart illustrating a method 1800 of implementing a digital assistant that provides an explanation for a deviation between a predicted future value and a planned future value for a monitored data object, in accordance with some example embodiments. The method 1800 can be performed by processing logic that can comprise hardware (e.g., circuitry, dedicated logic, programmable logic, microcode, etc.), software (e.g., instructions run on a processing device), or a combination thereof. In one example embodiment, one or more of the operations of the method 1800 are performed by the digital assistant system 300 of FIG. 3, or any combination of one or more of its components, is implemented as described above.

At operation 1810, the digital assistant system 300 identifies corresponding deviations between predicted future values for other data objects and planned future values for the other data objects that contributed to the deviation for the monitored data object. At operation 1820, the digital assistant system 300 causes at least a portion of the corresponding deviations for the other data objects to be displayed on the computing device as an explanation for the deviation for the monitored data object.

It is contemplated that any of the other features described within the present disclosure can be incorporated into the method 1800.

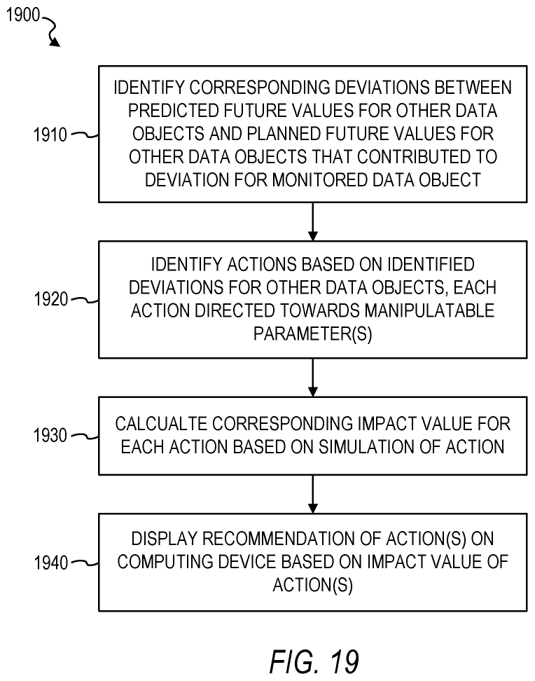

FIG. 19 is a flowchart illustrating a method 1900 of implementing a digital assistant that provides a recommendation of one or more actions to avoid a deviation, in accordance with some example embodiments. The method 1900 can be performed by processing logic that can comprise hardware (e.g., circuitry, dedicated logic, programmable logic, microcode, etc.), software (e.g., instructions run on a processing device), or a combination thereof. In one example embodiment, one or more of the operations of the method 1900 are performed by the digital assistant system 300 of FIG. 3, or any combination of one or more of its components, is implemented as described above.

At operation 1910, the digital assistant system 300 identifies corresponding deviations between predicted future values for other data objects and planned future values for the other data objects that contributed to the deviation for the monitored data object. At operation 1920, the digital assistant system 300 identifies a plurality of actions based on the identifying of the corresponding deviations for the other data objects, with each one of the plurality of actions being directed towards at least one manipulatable parameter. At operation 1930, the digital assistant system 300 calculates a corresponding impact value for each one of the plurality of actions based on a simulation of the plurality of actions. At operation 1940, the digital assistant system 300 causes a recommendation of at least one of the plurality of actions to be displayed on the computing device based on the corresponding impact value of the at least one of the plurality of actions, with the at least one of the plurality of actions being displayed as an action to avoid the deviation of the monitored data object or the deviation of one of the other data objects.

It is contemplated that any of the other features described within the present disclosure can be incorporated into the method 1900.

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses that connect the hardware modules). In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the network 114 of FIG. 1) and via one or more appropriate interfaces (e.g., APIs).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

A computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

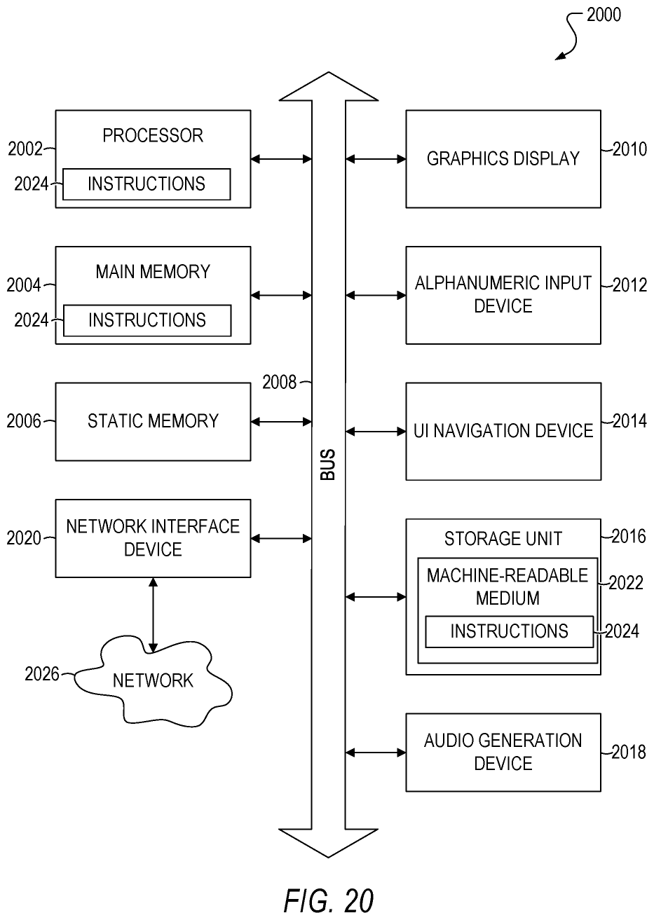

FIG. 20 is a block diagram of a machine in the example form of a computer system 2000 within which instructions 2024 for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 2000 includes a processor 2002 (e.g., a central processing unit (CPU), a graphics processing unit (GPU) or both), a main memory 2004, and a static memory 2006, which communicate with each other via a bus 2008. The computer system 2000 may further include a graphics or video display unit 2010 (e.g., a liquid crystal display (LCD) or a cathode ray tube (CRT)). The computer system 2000 also includes an alphanumeric input device 2012 (e.g., a keyboard), a user interface (UI) navigation (or cursor control) device 2014 (e.g., a mouse), a storage unit (e.g., a disk drive unit) 2016, an audio or signal generation device 2018 (e.g., a speaker), and a network interface device 2020.

The storage unit 2016 includes a machine-readable medium 2022 on which is stored one or more sets of data structures and instructions 2024 (e.g., software) embodying or utilized by any one or more of the methodologies or functions described herein. The instructions 2024 may also reside, completely or at least partially, within the main memory 2004 and/or within the processor 2002 during execution thereof by the computer system 2000, the main memory 2004 and the processor 2002 also constituting machine-readable media. The instructions 2024 may also reside, completely or at least partially, within the static memory 2006.

While the machine-readable medium 2022 is shown in an example embodiment to be a single medium, the term “machine-readable medium” may include a single medium or multiple media (e.g., a centralized or distributed database, and/or associated caches and servers) that store the one or more instructions 2024 or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

The instructions 2024 may further be transmitted or received over a communications network 2026 using a transmission medium. The instructions 2024 may be transmitted using the network interface device 2020 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding, or carrying instructions for execution by the machine, and includes digital or analog communications signals or other intangible media to facilitate communication of such software.

Each of the features and teachings disclosed herein can be utilized separately or in conjunction with other features and teachings to provide a system and method for blind spot implementation in neural networks. Representative examples utilizing many of these additional features and teachings, both separately and in combination, are described in further detail with reference to the attached figures. This detailed description is merely intended to teach a person of skill in the art further details for practicing certain aspects of the present teachings and is not intended to limit the scope of the claims. Therefore, combinations of features disclosed above in the detailed description may not be necessary to practice the teachings in the broadest sense, and are instead taught merely to describe particularly representative examples of the present teachings.

Some portions of the detailed descriptions herein are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the below discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may include a general purpose computer selectively activated or reconfigured by a computer program stored in the computer. Such a computer program may be stored in a computer readable storage medium, such as, but not limited to, any type of disk, including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The example methods or algorithms presented herein are not inherently related to any particular computer or other apparatus. Various general purpose systems, computer servers, or personal computers may be used with programs in accordance with the teachings herein, or it may prove convenient to construct a more specialized apparatus to perform the method steps disclosed herein. The structure for a variety of these systems will appear from the description herein. It will be appreciated that a variety of programming languages may be used to implement the teachings of the disclosure as described herein.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to aid in understanding how the present teachings are practiced, but not intended to limit the dimensions and the shapes shown in the examples.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

### EXAMPLES

1. A computer-implemented method comprising:
detecting, by at least one hardware processor, a data change in one or more data sources, the data change corresponding to a monitored data object;
generating, by the at least one hardware processor, a predicted future value for the monitored data object based on the detected data change;
identifying, by the at least one hardware processor, a deviation between the predicted future value for the monitored data object and a planned future value for the monitored data object;
determining, by the at least one hardware processor, that the identified deviation exceeds a threshold value; and
causing, by the at least one hardware processor, a notification corresponding to the deviation to be displayed on a computing device based on the determination that the identified deviation exceeds the threshold value.

2. The computer-implemented method of example 1, wherein the notification corresponding to the deviation is caused to be displayed based on a role of a user of the computing device.

3. The computer-implemented method of example 1 or example 2, wherein the notification corresponding to the deviation is caused to be displayed based on one or more characteristics of the computing device.

4. The computer-implemented method of any one of examples 1 to 3, wherein the one or more characteristics of the computing device comprise one or more of a type of the computing device and a screen size of the computing device.

5. The computer-implemented method of any one of examples 1 to 4, wherein the notification corresponding to the deviation is caused to be displayed based on one or more upcoming meetings identified from an electronic calendar of a user of the computing device.

6. The computer-implemented method of any one of examples 1 to 5, wherein the notification corresponding to the deviation is caused to be displayed based on one or more previous conversations between a user of the computing device and a digital assistant.

7. The computer-implemented method of any one of examples 1 to 6, further comprising:
identifying, by the at least one hardware processor, corresponding deviations between predicted future values for other data objects and planned future values for the other data objects that contributed to the deviation for the monitored data object; and
causing, by the at least one hardware processor, at least a portion of the corresponding deviations for the other data objects to be displayed on the computing device as an explanation for the deviation for the monitored data object.

8. The computer-implemented method of any one of examples 1 to 7, further comprising:
identifying, by the at least one hardware processor, corresponding deviations between predicted future values for other data objects and planned future values for the other data objects that contributed to the deviation for the monitored data object;
identifying, by the at least one hardware processor, a plurality of actions based on the identifying of the corresponding deviations for the other data objects, each one of the plurality of actions being directed towards at least one manipulatable parameter;
calculating, by the at least one hardware processor, a corresponding impact value for each one of the plurality of actions based on a simulation of the plurality of actions; and
causing, by the at least one hardware processor, a recommendation of at least one of the plurality of actions to be displayed on the computing device based on the corresponding impact value of the at least one of the plurality of actions, the at least one of the plurality of actions being displayed as an action to avoid the deviation of the monitored data object or the deviation of one of the other data objects.

9. A system comprising:
at least one processor; and
a non-transitory computer-readable medium storing executable instructions that, when executed, cause the at least one processor to perform the method of any one of examples 1 to 8.

10. A non-transitory machine-readable storage medium, tangibly embodying a set of instructions that, when executed by at least one processor, causes the at least one processor to perform the method of any one of examples 1 to 8.

11. A machine-readable medium carrying a set of instructions that, when executed by at least one processor, causes the at least one processor to carry out the method of any one of examples 1 to 8.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A computer-implemented method comprising:
detecting, by at least one hardware processor, a data change in one or more data sources, the data change corresponding to a monitored data object;
generating, by the at least one hardware processor, a predicted future value for the monitored data object based on the detected data change;
identifying, by the at least one hardware processor, a deviation between the predicted future value for the monitored data object and a planned future value for the monitored data object;
determining, by the at least one hardware processor, that the identified deviation is relevant to a user of a computing device; and
causing, by the at least one hardware processor, a notification corresponding to the deviation to be displayed on the computing device based on the determination that the identified deviation is relevant to the user of the computing device.

2. The computer-implemented method of claim 1, wherein the notification corresponding to the deviation is caused to be displayed based on a role of the user of the computing device.

3. The computer-implemented method of claim 1, wherein the notification corresponding to the deviation is caused to be displayed based on one or more characteristics of the computing device.

4. The computer-implemented method of claim 3, wherein the one or more characteristics of the computing device comprise one or more of a type of the computing device and a screen size of the computing device.

5. The computer-implemented method of claim 1, wherein the notification corresponding to the deviation is caused to be displayed based on one or more upcoming meetings identified from an electronic calendar of the user of the computing device.

6. The computer-implemented method of claim 1, wherein the notification corresponding to the deviation is caused to be displayed based on one or more previous conversations between the user of the computing device and a digital assistant.

7. The computer-implemented method of claim 1, further comprising:
identifying, by the at least one hardware processor, corresponding deviations between predicted future values for other data objects and planned future values for the other data objects that contributed to the deviation for the monitored data object; and
causing, by the at least one hardware processor, at least a portion of the corresponding deviations for the other data objects to be displayed on the computing device as an explanation for the deviation for the monitored data object.

8. The computer-implemented method of claim 1, further comprising:
identifying, by the at least one hardware processor, corresponding deviations between predicted future values for other data objects and planned future values for the other data objects that contributed to the deviation for the monitored data object;
identifying, by the at least one hardware processor, a plurality of actions based on the identifying of the corresponding deviations for the other data objects, each one of the plurality of actions being directed towards at least one manipulatable parameter;
calculating, by the at least one hardware processor, a corresponding impact value for each one of the plurality of actions based on a simulation of the plurality of actions; and
causing, by the at least one hardware processor, a recommendation of at least one of the plurality of actions to be displayed on the computing device based on the corresponding impact value of the at least one of the plurality of actions, the at least one of the plurality of actions being displayed as an action to avoid the deviation of the monitored data object or the deviation of one of the other data objects.

9. A system comprising:
at least one hardware processor; and
a non-transitory computer-readable medium storing executable instructions that, when executed, cause the at least one processor to perform operations comprising:
detecting a data change in one or more data sources, the data change corresponding to a monitored data object;
generating a predicted future value for the monitored data object based on the detected data change;
identifying a deviation between the predicted future value for the monitored data object and a planned future value for the monitored data object;
determining that the identified deviation exceeds a threshold value; and
causing a notification corresponding to the deviation to be displayed on a computing device based on the determination that the identified deviation exceeds the threshold value.

10. The system of claim 9, wherein the notification corresponding to the deviation is caused to be displayed based on a role of a user of the computing device.

11. The system of claim 9, wherein the notification corresponding to the deviation is caused to be displayed based on one or more characteristics of the computing device.

12. The system of claim 11, wherein the one or more characteristics of the computing device comprise one or more of a type of the computing device and a screen size of the computing device.

13. The system of claim 9, wherein the notification corresponding to the deviation is caused to be displayed based on one or more upcoming meetings identified from an electronic calendar of a user of the computing device.

14. The system of claim 9, wherein the notification corresponding to the deviation is caused to be displayed based on one or more previous conversations between a user of the computing device and a digital assistant.

15. The system of claim 9, wherein the operations further comprise:
identifying corresponding deviations between predicted future values for other data objects and planned future values for the other data objects that contributed to the deviation for the monitored data object; and
causing at least a portion of the corresponding deviations for the other data objects to be displayed on the computing device as an explanation for the deviation for the monitored data object.

16. The system of claim 9, wherein the operations further comprise:
identifying corresponding deviations between predicted future values for other data objects and planned future values for the other data objects that contributed to the deviation for the monitored data object;
identifying a plurality of actions based on the identifying of the corresponding deviations for the other data objects, each one of the plurality of actions being directed towards at least one manipulatable parameter;
calculating a corresponding impact value for each one of the plurality of actions based on a simulation of the plurality of actions; and
causing a recommendation of at least one of the plurality of actions to be displayed on the computing device based on the corresponding impact value of the at least one of the plurality of actions, the at least one of the plurality of actions being displayed as an action to avoid the deviation of the monitored data object or the deviation of one of the other data objects.

17. A non-transitory machine-readable storage medium, tangibly embodying a set of instructions that, when executed by at least one hardware processor, causes the at least one processor to perform operations comprising:
detecting a data change in one or more data sources, the data change corresponding to a monitored data object;
generating a predicted future value for the monitored data object based on the detected data change;
identifying a deviation between the predicted future value for the monitored data object and a planned future value for the monitored data object;
determining that the identified deviation exceeds a threshold value; and
causing a notification corresponding to the deviation to be displayed on a computing device based on the determination that the identified deviation exceeds the threshold value.

18. The non-transitory machine-readable storage medium of claim 17, wherein the notification corresponding to the deviation is caused to be displayed based on at least one of: a role of a user of the computing device, one or more characteristics of the computing device, one or more upcoming meetings identified from an electronic calendar of the user of the computing device, and one or more previous conversations between the user of the computing device and a digital assistant.

19. The non-transitory machine-readable storage medium of claim 17, wherein the operations further comprise:
identifying corresponding deviations between predicted future values for other data objects and planned future values for the other data objects that contributed to the deviation for the monitored data object; and
causing at least a portion of the corresponding deviations for the other data objects to be displayed on the computing device as an explanation for the deviation for the monitored data object.

20. The non-transitory machine-readable storage medium of claim 17, wherein the operations further comprise:
identifying corresponding deviations between predicted future values for other data objects and planned future values for the other data objects that contributed to the deviation for the monitored data object;
identifying a plurality of actions based on the identifying of the corresponding deviations for the other data objects, each one of the plurality of actions being directed towards at least one manipulatable parameter;
calculating a corresponding impact value for each one of the plurality of actions based on a simulation of the plurality of actions; and
causing a recommendation of at least one of the plurality of actions to be displayed on the computing device based on the corresponding impact value of the at least one of the plurality of actions, the at least one of the plurality of actions being displayed as an action to avoid the deviation of the monitored data object or the deviation of one of the other data objects.
